(19) United States
(12) Patent Application Publication
(10) Pub. No.: US 2017/0205816 A1
(43) Pub. Date: Jul. 20, 2017

(54) ABNORMALITY DETECTION METHOD AND ABNORMALITY DETECTION APPARATUS

(71) Applicant: FUJITSU LIMITED, Kawasaki-shi (JP)

(72) Inventor: Koichi Onoue, Kawasaki (JP)

(73) Assignee: FUJITSU LIMITED, Kawasaki-shi (JP)

(21) Appl. No.: 15/398,759

(22) Filed: Jan. 5, 2017

(30) Foreign Application Priority Data
Jan. 18, 2016 (JP) 2016-007215

(51) Int. Cl. G05B 23/02

(52) U.S. Cl. CPC G05B 23/0208

(57) ABSTRACT

An abnormality detection method includes first acquiring, classifying, storing, second acquiring and determining. First acquiring acquires data about a predetermined item of a processing apparatus per segment from the apparatus, the segment being obtained by segmenting one period into a plurality of segments, the apparatus iteratively executing processes. Classifying classifies the data acquired by the first acquiring into a plurality of groups by a predetermined classification criterion. Storing stores an occurrence frequency of the data in the one period per group. Second acquiring acquires data about the predetermined item per segment in a determination target period, the determination target period having a same length as a length of the one period. Determining determines existence of abnormality in the apparatus when occurrence frequency of data in the determination target period per group deviates from an allowable range based on the occurrence frequency of the data in the one period.

### CROSS-REFERENCE TO RELATED APPLICATIONS

This application is based upon and claims the benefit of priority of the prior Japanese Patent Application No. 2016-007215, filed on Jan. 18, 2016, the entire contents of which are incorporated herein by reference.

### FIELD

The embodiments discussed herein are related to an abnormality detection method and an abnormality detection apparatus.

### BACKGROUND

In a system configured to include a plurality of resources instanced by a server and a storage in a data center and other equivalent data facilities, such a method exists as to detect abnormality by comparing values collected with respect to an item in processes to be executed iteratively with normal patterns prepared beforehand. The normal patterns are generated by collecting the values of the item under a condition not affected by settings, states and other equivalent elements of other resources within the system, and defining an allowable value range from the plurality of collected values. The system periodically collects the values of the item, and determines the abnormality when there is an item deviating from the allowable value range in comparison with the normal patterns.

A method is known, which obtains an average value of the plurality of values collected with respect to the item, corresponding to the average value and an allowable range of deviation from the average value, on the occasion of defining the normal pattern.

### DOCUMENTS OF RELATED ARTS

### Patent Document

[Patent document 1] Japanese Laid-open Patent Publication No. 2015-108990
[Patent document 2] Japanese Laid-open Patent Publication No. 2015-36961

### Non-Patent Document

[Non-Patent document 1] Tsunenori Ishioka, “An Expansion of X-means for Automatically Determining the Optimal Number of Clusters,” the Fourth TASTED International Conference on Computational Intelligence, Calgary, Alberta, Canada, Jul. 4-6, 2005, pp. 91-96

### SUMMARY

According to one mode, there is provided an abnormality detection method. The abnormality detection method includes first acquiring, first classifying, first storing, second acquiring and first determining. First acquiring acquires data about a predetermined item of a processing apparatus per segment from the processing apparatus, the segment being obtained by segmenting one period into a plurality of segments, the processing apparatus iteratively executing processes. First classifying classifies the data acquired by the first acquiring into a plurality of groups by a predetermined classification criterion. First storing stores an occurrence frequency of the data in the one period per group. Second acquiring acquires data about the predetermined item per segment in a determination target period, the determination target period having a same length as a length of the one period. First determining determines existence of abnormality in the processing apparatus when occurrence frequency of data in the determination target period per group deviates from an allowable range based on the occurrence frequency of the data in the one period.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating an outline of how abnormality is detected based on collected data;

FIG. 2 is a diagram illustrating an example of a method of generating a normal model based on an average value;

FIG. 3 is a diagram illustrating an example of the normal model generated based on the average value from data at a learning stage having periodicity;

FIG. 4 is a diagram illustrating an example of comparing collected data of normal/abnormal states in a state model update period with a range of data of the normal state in the normal model based on the average value;

FIG. 5 is a diagram illustrating a specific example of a state model based on an occurrence frequency;

FIG. 6 is a diagram illustrating an example of comparing the collected data of the normal/abnormal states in the state model update period with the range of the data of the normal state in the state model based on the occurrence frequency;

FIG. 7 is a diagram illustrating one example of a hardware configuration of an abnormality detection apparatus;

FIG. 8 is a diagram illustrating one example of components of the abnormality detection apparatus;

FIG. 9 is a flowchart illustrating an example of a process of classifying collected data by X-means;

FIG. 10 is a diagram illustrating one example of a data structure of the collected data;

FIG. 11A is a diagram illustrating an example of the state model at 10:00 am;

FIG. 11B is a diagram illustrating an example of the state model at 11:00 am;

FIG. 12A is a diagram illustrating an example of the state model at 10:00 am, including the occurrence frequency;

FIG. 12B is a diagram illustrating an example of the state model at 11:00 am, including the occurrence frequency;

FIG. 13 is a diagram illustrating an example of a data structure of the state model;

FIG. 14 is a diagram illustrating an example of determining the abnormality in the state model update period;

FIG. 15 is a diagram illustrating an example of a data structure of information related to the detected abnormality;

FIG. 16 is a flowchart illustrating an example of a process of generating the state model;

FIG. 17 is a flowchart illustrating an example of an abnormality determination process in an embodiment 1;

FIG. 18A is a diagram illustrating an example of how the state model is selected;

FIG. 18B is a diagram illustrating an example of how the state model is selected;

FIG. 19 is a flowchart illustrating the abnormality determination process in an embodiment 2;

FIG. 20A is a diagram illustrating an example of the state model at 10:00 am, including a transition rate;

FIG. 20B is a diagram illustrating an example of the state model at 11:00 am, including the transition rate;

FIG. 21 is a diagram illustrating an example of a data structure of the state model in an embodiment 3;

FIG. 22 is a diagram illustrating an example of determining the abnormality in the state model update period in the embodiment 3;

FIG. 23 is a flowchart illustrating an example of a process of generating the state model in the embodiment 3; and

FIG. 24 is a flowchart illustrating an example of the abnormality determination process in the embodiment 3.

### DESCRIPTION OF EMBODIMENTS

When the normal pattern is defined based on the average value, for example, the abnormality is determined as the case may be because of deviating from the allowable value range in spite of a result of a normal operation with respect to the item taking discrete values from the average value. A phrase “taking the discrete values from the average value” connotes such an occurrence state of values that the plurality of collected values of the item takes values larger than the average value and values smaller than the average value, with the average value being interposed therebetween.

Embodiment of the present invention will hereinafter be described based on the drawings. Configurations of the following embodiments are exemplifications, and the present invention is not limited to the configurations of the embodiments.

<Abnormality Detection>

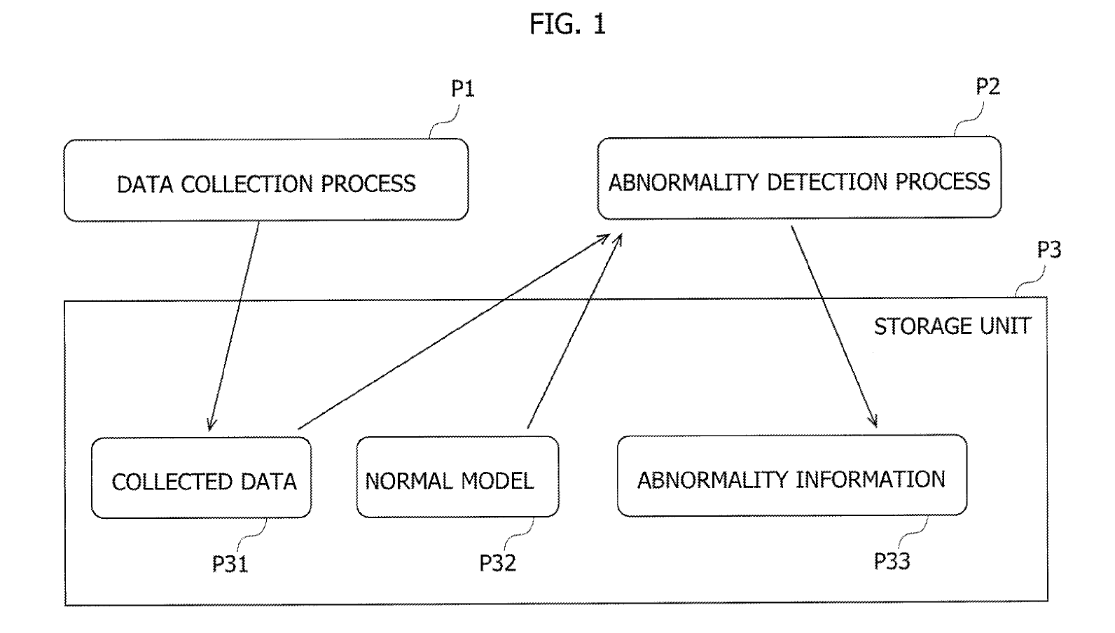

FIG. 1 is a diagram illustrating an outline of how an abnormality is detected based on collected data. A data collecting Process P1 collects data, which indicate settings/states of respective resources, from a processing apparatus and other equivalent apparatuses in order to detect the abnormality in the processing apparatus and other equivalent apparatuses iteratively executing processes. The data to be collected are numeric data representing the settings/states about physical/virtual resources instanced by a server, a network, a storage, a Virtual Machine (VM), a Virtual switch, a Virtual router, a Hypervisor and a Process, which are all abnormality detection targets. The data collecting Process P1 acquires collected data P31 at a fixed interval (e.g., a 60 sec interval), and stores the collected data P31 in a storage unit P3. The fixed interval, at which to collect the data, is also termed a data collecting segment.

Note that each of the following embodiments will exemplify an abnormality detection apparatus to detect the abnormality of the abnormality detection target (the processing apparatus and other equivalent apparatuses) being active in processing periodic processes. Herein, the periodic processes are instanced by processes or services of an information system of the server and other equivalent apparatuses, these processes or services being provided for user's tasks that are iteratively performed as on a per time basis, per day basis, per week basis or per month basis.

An abnormality detection Process P2 generates a normal model (which will hereinafter be referred to as a state model) P32 with a fixed period (e.g., one-day period), based on the collected data P31 stored in a storage unit P3. The fixed period, during which the normal model P32 is generated, is also referred to as a state model update period or simply the period. The generated normal model P32 is stored in the storage unit P3. The abnormality detection Process P2 detects whether the abnormality occurs by comparing the collected data P31 collected by the data collecting Process P1 during the state model update period of an abnormality detection determining target (which will hereinafter also be termed a determining target period) with the normal model P32 stored in the storage unit P3. The abnormality detection Process P2 stores detected abnormality information P33 in the storage unit P3.

Herein, the abnormality connotes a state of deviating from the normal model P32. For example, the normal model P32 indicates that a value of the collected data instanced by a usage rate of a Central Processing Unit (CPU) falls within a predetermined range. In other words, the normal model P32 is defined as such a piece of information that “the CPU usage rate is equal to or smaller than 70%”. The normal model P32 may also be such a piece of information that “a frequency rate of occurrences of a segment with the CPU usage rate becoming equal to or larger than 50% in one period segmented into a plurality of segments”.

When detecting the abnormality with respect to a plurality of items instanced by the CPU usage rate and a memory usage rate, generation of the normal model and the abnormality detection are implemented per item. Upon detecting the abnormality, the user is notified of the occurrence of the abnormality per item.

<Normal Model Based on Average Value>

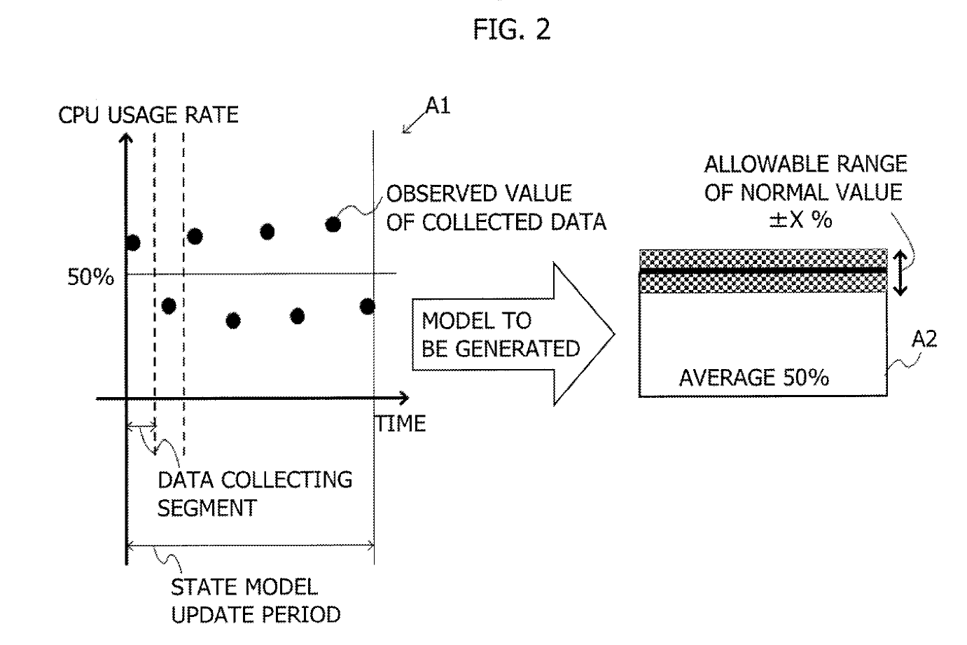

FIG. 2 is a diagram illustrating an example of a method of generating the normal model based on an average value. A graph A1 illustrated in FIG. 2 represents a relationship between the time and the CPU usage rate, in which the axis of abscissa indicates the time, and the axis of ordinate indicates the CPU usage rate. The CPU usage rate is measured per data collecting segment obtained by equally segmenting the state model update period into a predetermined number of segments. A solid black circle indicates an observed value of the CPU usage rate measured per data collecting segment. In the example of FIG. 2, the observed values are averaged at 50%; and, however, the observed values are discretized above and under a 50% line. A normal model A2 depicted in FIG. 2 is generated based on the observed values given in the graph A1. The normal model A2 is a normal model based on the average values, in which an allowable range of the normal values is a range covering values from −x % to +x % of the average value “50%”. An x-value can be set to, e.g., such a value that the allowable range does not encompass the observed values given when the abnormality detection target processing apparatus operates abnormally.

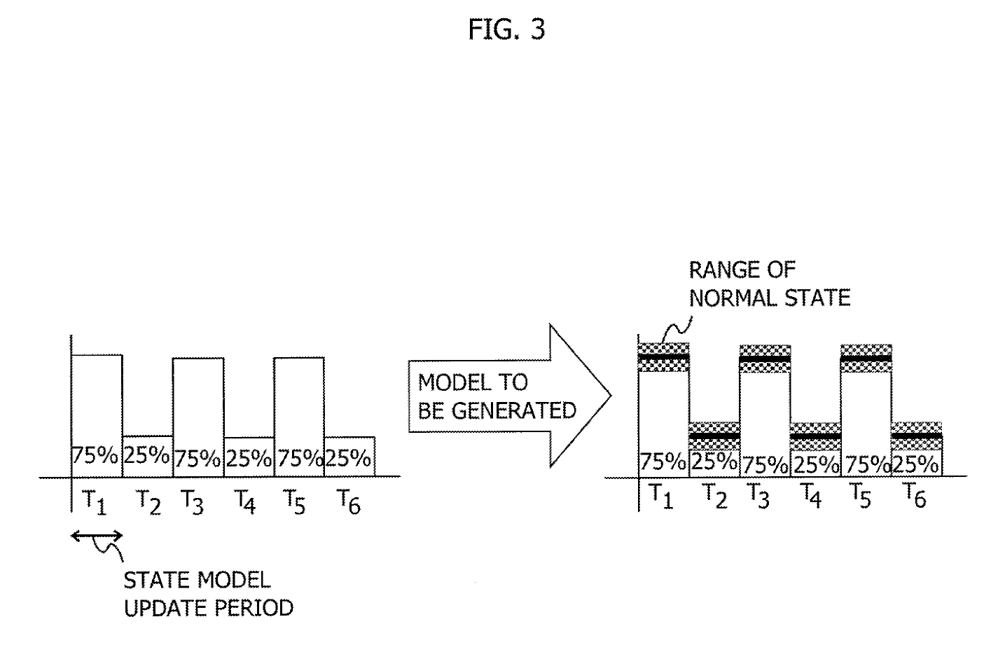

FIG. 3 is a diagram illustrating an example of the normal model generated based on the average values from data at a learning stage with periodicity. The learning stage is defined as a time length for collecting the data used for generating the normal model, and contains one or more state model update periods. The state model update period is notated by Tᵢ (i=1, 2, . . . ). In each of the state model update periods T₁, T₃, T₅, the average value of the observed values of the data collected per data collecting segment is 75%. In each of the state model update periods T₂, T₄, T₆, the average value of the observed values of the data collected per data collecting segment is 25%.

The normal model of the state model update periods T₁ through T₆ is generated based on the average values of the respective state model update periods T₁ at the learning stage. In the state model update periods T₁, T₃, T₅, a normal state range is to range from the average value “75%” to a predetermined threshold value. In the state model update periods T_{z}, T₄, T₆, the normal state range is to range from the average value “25%” to the predetermined threshold value.

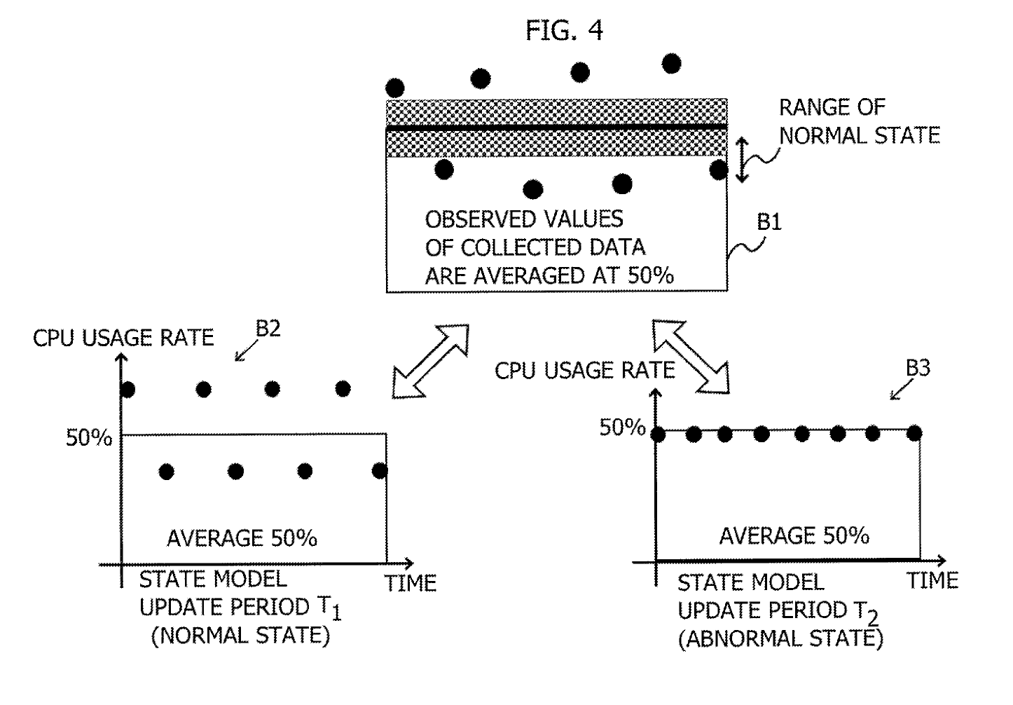

FIG. 4 is a diagram illustrating an example of making an erroneous determination when comparing the collected data of the normal/abnormal states in one state model update period with a range of data of the normal state in the normal model based on the average values. A normal model B1 is a normal model based on the average values generated from the collected data for one state model update period depicted in the graph A1 of FIG. 2. The average value of the collected data for one state model update period depicted in the graph A1 is 50%. In the normal model B1, the range from the average value “50%” to the predetermined threshold value is deemed as the normal state range.

A graph B2 depicted in FIG. 4 represents, similarly to FIG. 2, a relationship between the time in the state model update period T₁ and the CPU usage rate. In the graph B2, the observed values are discretized above and under the 50% line similarly to the graph A1 in FIG. 2 illustrating the normal state, and, however, the range of the normal state in the normal model B1 does not include the respective observed values of the collected data in the graph B2. Accordingly, the collected data given in the graph B2 are determined to be “abnormal” even though being “normal” when compared with the normal model B1 based on the average values.

A graph B3 illustrated in FIG. 4 represents, similarly to FIG. 2, a relationship between the time in the state model update period T₂ and the CPU usage rate. The observed values in the graph B3 take substantially fixed values in the vicinity of average value (50%), and are therefore determined to be “normal” even though being “abnormal” when compared with the normal model B1 based on the average values.

According to the normal model B1 based on the average values, the collected data in the graph B2 indicating the normal state are determined to be “abnormal”, while the collected data in the graph B3 indicating the abnormal state are determined to be “normal”. In other words, such a case arises that the normal state and the abnormal state are not correctly determined when using the normal model based on the average values.

### Embodiment 1

In an embodiment 1, the data indicating the settings/states of the resources of the processing apparatuses and other equivalent apparatuses are collected from these processing apparatuses becoming the abnormality detection targets. The collected data in one state model update period are classified into a plurality of states, and there is generated the normal model (the state model) to which information on an occurrence frequency per state is added. A determination about whether the abnormality occurs is made based on whether the occurrence frequency per state of the collected data exceeds the allowable range from the state model. The following discussion will be made on the assumption that the data collection and the abnormality detection are targeted at the CPU usage rate, and, however, the embodiment is not limited to the CPU usage rate. For example, a memory usage rate, a Process count and a network usage may also be available.

<State Model Based on Occurrence Frequency>

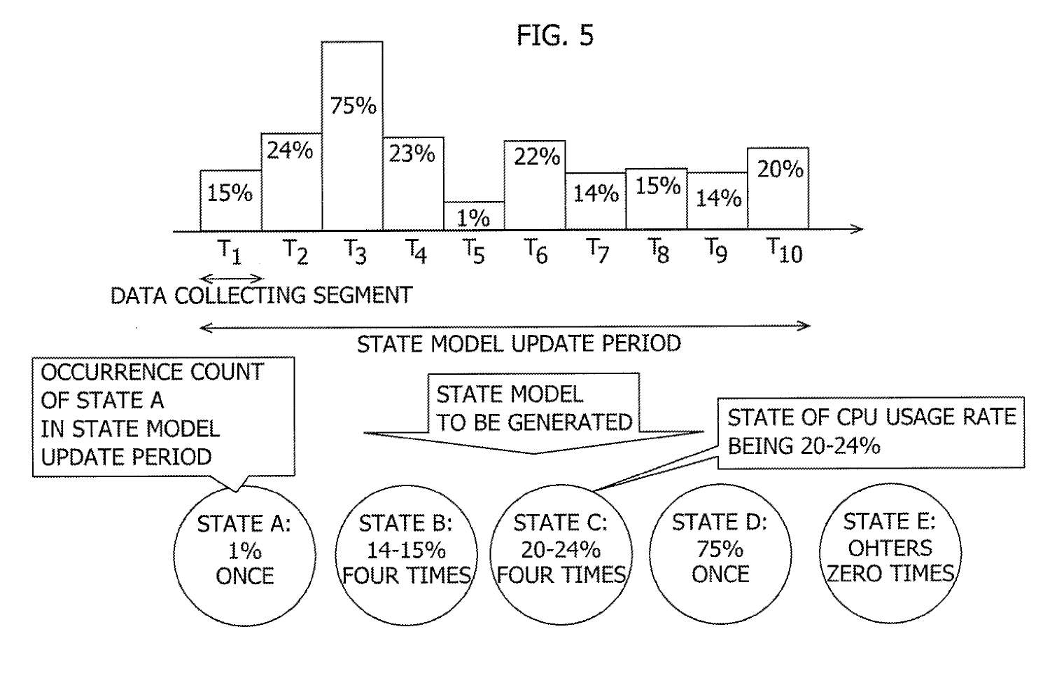

FIG. 5 is a diagram illustrating an example of the state model based on the occurrence frequency. The state model is generated per state model update period. The state model update period is equally segmented into a predetermined number of data collecting segments. A segment count can be properly set. In the embodiment 1, the data collected in the respective data collecting segments are classified into a plurality of aggregations (which will hereinafter be referred to as clusters or groups) by clustering or grouping.

In the embodiment 1, occurrence counts of the data belonging to the respective groups are counted in one state model update period. The occurrence count of the data belonging to each group is used as a threshold value for determining whether an operation of the processing apparatus in one period is abnormal.

In a determination target period, when the occurrence count of the data belonging to each group exceeds the threshold value of each group in the state model, the operation of the processing apparatus in the period concerned is determined abnormal. The abnormality determination is carried out per data collecting segment. To be specific, the occurrence count of the data belonging to each group in the determination target period is counted per data collecting segment, and the counted occurrence count is determined abnormal when exceeding the threshold value in the state model. Note that the abnormality determination may also be made based on a comparison between the occurrence count of each group in the determination target period and the threshold value in the state model after an elapse of one period.

In the example illustrated in FIG. 5, the state model update period is equally segmented into data collecting segments t1-t10. The observed values of the CPU usage rates, which are collected in the individual data collecting segments, are classified into five groups of states A-E. In the example of FIG. 5, the state A corresponds to the group containing the data with the CPU usage rate being 1%. The state B corresponds to the group containing the data with the CPU usage rate being 14%-15%. The state C corresponds to the group containing the data with the CPU usage rate being 20%-24%. The state D corresponds to the group containing the data with the CPU usage rate being 75%. The state E corresponds to the group containing the data belonging to none of the states A-D.

The CPU usage rate becomes 1% once in the data collecting segment t5, and the occurrence count of the state A in one state model update period is “1”. Similarly, the CPU usage rate becomes 14%-15% four times in the data collecting segments t1 and t7-t9, and the occurrence count of the state B is “4” The CPU usage rate becomes 20%-24% four times in the data collecting segments t2, t4, t6 and t10, and the occurrence count of the state C is “4”. The CPU usage rate becomes 75% once in the data collecting segment t3, and the occurrence count of the state D is “1”. The CPU usage rate not included in the states A-D is not observed, and hence the occurrence count of the state E is “0”. The states A-E generated from the state model update periods including the data collecting segments t1-t10 are the state models, of which the occurrence counts are set as the threshold values.

The abnormality determination based on the state models illustrated in FIG. 5 is carried out as follows. Data collecting segments t21, t22, t23 are to be the data collecting segments included by a period different from the state model update period including the segments t1-t10. The following are the CPU usage rates in the data collecting segments t21, t22, t23 and examples of determination results.

### t21: CPU Usage Rate 24%→Normal (State C's Occurrence Count=1)

### t22: CPU Usage Rate 75%→Normal (State D's Occurrence Count=1)

### t23: CPU Usage Rate 75%→Abnormal (State D's Occurrence Count=2)

The CPU usage rate is 24% in the segment t21, and therefore the occurrence count of the state C becomes “1”. The occurrence count of the state C in the period concerned is equal to or smaller than the occurrence count “4” of the state C in the state model, and hence the determination result is normal. The CPU usage rate is 75% in the segment t22, and hence the occurrence count of the state D becomes “1”. The occurrence count of the state D in the period concerned is equal to or smaller than the occurrence count “1” of the state D in the state model, and therefore the determination result is normal. The CPU usage rate is 75% in the segment t23, and hence the occurrence count of the state D becomes “2”. The occurrence count of the state D in the period concerned is larger than the occurrence count “1” of the state D in the state model, and therefore the determination result is abnormal. In the example of FIG. 5, the occurrence count in each state is expressed as the occurrence frequency, and, however, the occurrence frequency may be set as a ratio of the occurrence count of the data belonging to each state to a number of the data collecting segments in one period.

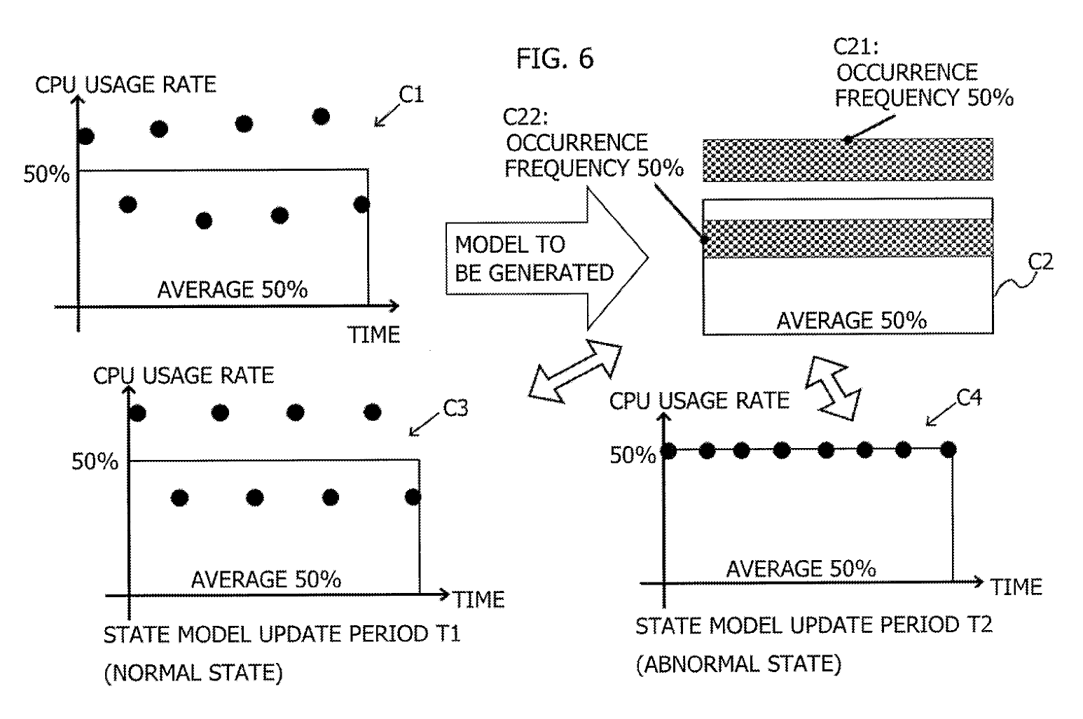

FIG. 6 is a diagram illustrating an example of comparing the collected data of the normal/abnormal states in one state model update period with a range of the data of the normal state in the state model based on the occurrence frequency. A graph C1 depicted in FIG. 6 represents a relationship between the time and the CPU usage rate, in which the axis of abscissa indicates the time, and the axis of ordinate indicates the CPU usage rate. The CPU usage rate is measured per data collecting segment obtained by equally segmenting the state model update period by the predetermined number. The solid black circle indicates the observed value of the CPU usage rate measured per data collecting segment. In the example of FIG. 6, the average value of the observed values is 50%; and, however, the observed values are discretized above and under the 50% line.

A normal model C2 illustrated in FIG. 6 is generated based on the observed values given in the graph C1. The normal model C2 is a normal model based on the occurrence frequency. The observed values of the collected data in the graph C1 are classified into two groups, e.g., a group C21 falling within a range of the values larger than 50% and a group C22 falling within a range of the values smaller than 50%. The data belonging to the state C21 occur four times, and the data belonging to the state C22 occur four times.

Accordingly, in the state model C2, the range of the normal state is deemed to cover the data belonging to the group C21 falling within the range of the values larger than 50% of the average value and the data belonging to the group C22 falling within the range of the values smaller than 50% of the average value. Each of the occurrence frequencies of the groups C21 and C22 is 50%. In the embodiment 1, the collected data are classified into the plurality of groups, corresponding to the observed values, and the occurrence frequency based on a number of pieces of data belonging to each group is used as a condition for determining whether abnormal or not.

A graph C3 illustrated in FIG. 6 represents, similarly to the graph C1, a relationship between the time and the CPU usage rate in a state model update period T₁. The observed values in the graph C3 are discretized above and under the 50% line similarly to the graph C1 indicating the normal state. The observed values larger than 50% in the collected data in the graph C3 are observed four times out of eight and included by the group C21 as the range of the normal state of the state model C2. The observed values smaller than 50% in the collected data in the graph C3 are observed four times out of eight and included by the group C22 as the range of the normal state of the state model C2. To be specific, each of the occurrence frequencies of the observed values included by the groups C21 and C22 is 50%. Therefore, the collected data given in the graph C3 are determined “normal” when compared with the normal model C2 based on the occurrence frequency.

A graph C4 illustrated in FIG. 6 represents, similarly to the graph C1, a relationship between the time and the CPU usage rate in a state model update period T₂. The observed values in the graph C4 take substantially fixed values in the vicinity of the average value (50%), and the collected data in the graph C4 indicate the abnormal state. The respective observed values of the collected data in the graph C4 are included by neither the group C21 nor the group C22 as the ranges of the normal state of the normal model C2. The collected data given in the graph C4 are therefore determined “abnormal” when compared with the normal mode C2 based on the occurrence frequency.

According to the state model C2 based on the occurrence frequency, the collected data in the graph C3 indicating the normal state are determined “normal”, while the collected data in the graph C4 indicating the abnormal state are determined “abnormal”. Namely, when using the state model based on the occurrence frequency, the normal state and the abnormal state are determined correctly even in such a case that the collected data take the discrete values.

<Configuration of Apparatus>

Described next is the abnormality detection apparatus to detect the abnormality of the processing apparatus by using the foregoing normality/abnormality detection method of determining the normality/abnormality of the operation of the processing apparatus.

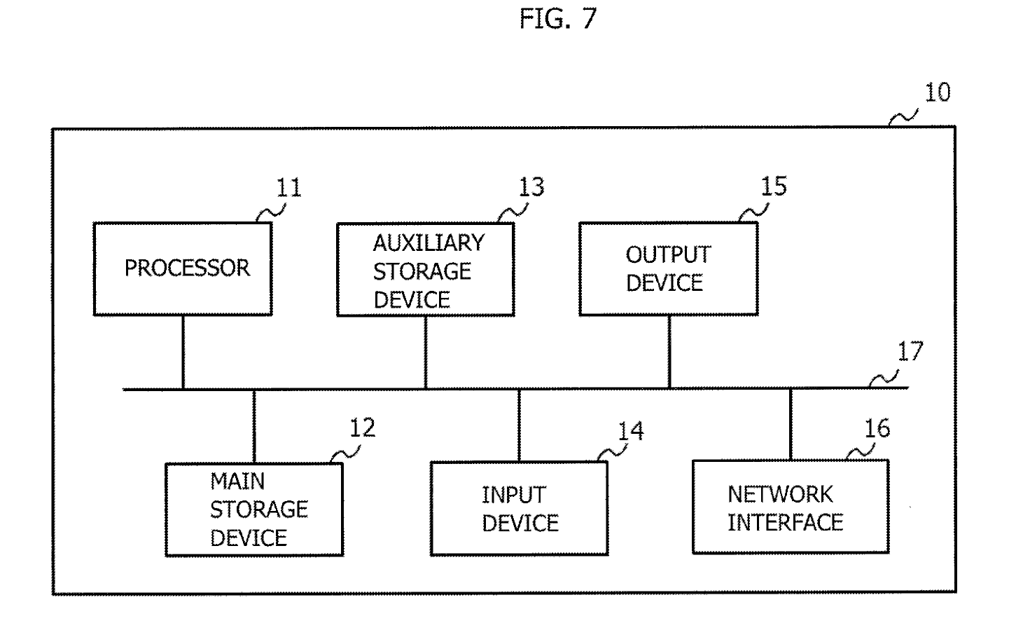

FIG. 7 is a diagram illustrating one example of a hardware configuration of an abnormality detection apparatus 10. The abnormality detection apparatus 10 includes a processor 11, a main storage device 12, an auxiliary storage device 13, an input device 14, an output device 15, and a network interface 16. The processor 11, the main storage device 12, the auxiliary storage device 13, the input device 14, the output device 15 and the network interface 16 are interconnected via a bus 17.

The processor 11 executes a variety of processes by loading an Operating System (OS) and various categories of computer programs, which are retained in the auxiliary storage device 13, onto the main storage device 12 and running the OS and the programs. A hardware circuit may also, however, execute part of the processes based on the computer programs. The processor 11 is instanced by the CPU and a Digital Signal Processor (DSP).

The main storage device 12 provides the processor 11 with storage areas for loading the programs stored in the auxiliary storage device 13 and work areas for running the programs. The main storage device 12 is used as a buffer for retaining the data. The main storage device 12 is a semiconductor memory instanced by a Read Only Memory (ROM) and a Random Access Memory (RAM).

The auxiliary storage device 13 stores the various categories of programs and the data used for the processor 11 to run these programs. The auxiliary storage device 13 is a nonvolatile memory instanced by an Erasable Programmable ROM (EPROM), a Hard Disk Drive (HDD) or a Solid State Drive (SSD). The auxiliary storage device 13 retains, e.g., the OS, the abnormality detection program and other various categories of application programs.

The input device 14 accepts an operation input from a user. The input device 14 is instanced by a pointing device like a touch pad, a mouse and a touch panel, a keyboard, operation buttons, and a circuit for receiving a signal from a remote controller. The output device 15 outputs information about the abnormality detected by the abnormality detection apparatus 10. The output device 15 is instanced by a Liquid Crystal Display (LCD).

The network interface 16 is an interface for inputting and outputting the information from and to the network. The network interface 16 includes an interface for establishing a connection to a wired network and an interface for establishing the connection to a wireless network. The network interface 16 is instanced by a Network Interface Card (NIC) and a wireless Local Area Network (LAN) card. The data and other equivalent information received by the network interface 16 are outputted to the processor 11. The abnormality detection apparatus 10 collects the data of the various types of resources connected via the network interface 16.

In the abnormality detection apparatus 10, e.g., the processor 11 loads the abnormality detection program retained in the auxiliary storage device 13 onto the main storage device 12, and runs this program. Note that the hardware configuration of the abnormality detection apparatus 10 is one example but is not limited to the configuration given above, and the components thereof can be properly omitted, replaced and added corresponding to the embodiment.

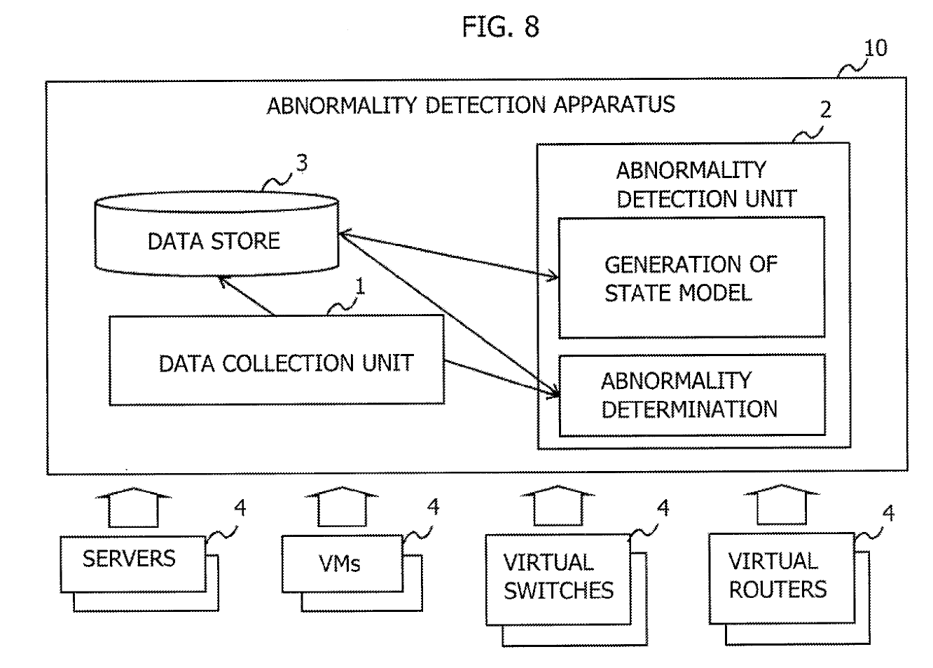

FIG. 8 is a diagram illustrating one example of components of the abnormality detection apparatus 10. The abnormality detection apparatus 10 includes the components, i.e., a data collection unit 1, an abnormality detection unit 2 and a data store 3. The abnormality detection apparatus 10 performs communications with a processing apparatus 4 defined as an abnormality detection target apparatus via the network interface 16. The processing apparatus 4 is instanced by Servers, Virtual Machines (VMs), Virtual switches and Virtual routers. The abnormality detection apparatus 10 collects the data indicating the settings/states of the respective resources from the individual processing apparatuses 4 through the communications.

Note that the abnormality detection apparatus 10 may also set the abnormality detection apparatus 10 itself as the abnormality detection target apparatus by collecting the data indicating the settings/states of the apparatus itself. In this case, the abnormality detection program may implement an abnormality determining process as an application program on a Personal Computer (PC) and other equivalent computers.

The data collection unit 1 collects the data indicating the settings/states of the respective resources on a segment-by-segment basis of the plurality of data collecting segments into which the state model update period is segmented, and stores the collected data in the data store 3. The collected data may also be transmitted per data collecting segment to the data collection unit 1 from the abnormality detection target processing apparatus 4.

The abnormality detection unit 2 generates the state model in a way that classifies the collected data in one state model update period, which are stored in the data store 3, into a plurality of groups, and stores the generated state model in the data store 3. The abnormality detection unit 2 compares the data collected by the data collection unit 1 with the state model stored in the data store 3, thus determining whether the abnormality exists. The data store 3 is generated in at least any one of the main storage device 12 and the auxiliary storage device 13.

The processor 11 runs the computer programs deployed in an executable manner on the main storage device 12, thereby performing and processing as the data collection unit 1 and the abnormality detection unit 2. The processor 11 performing as a data collection unit 1 collects the data from individual communication partner devices through the communications using the network interface 16.

Note that the hardware circuit may implement any of the data collection unit 1 and the abnormality detection unit 2 or part of processes thereof. The hardware circuit includes a Programmable Logic Device (PLD) instanced by a Field Programmable Gate Array (FPGA), and an Integrated Circuit (IC, Large Scale Integration (LSI), Application Specific Integrated Circuit (ASIC)).

The state model is one example of a “normal pattern”. The state model update period is one example of a “period”. The data collecting segment is one example of a “segment”. The data collection unit 1 is one example of an “acquiring unit”. The abnormality detection unit 2 is one example of a “determining unit”. The data store 3 is one example of a “storage unit”.

<Clustering>

Clustering is exemplified as a method of classifying a dataset, collected per plurality of segments obtained by segmenting the state model update period, into a plurality of datasets. The clustering is that the collected data are statistically classified into datasets (clusters) having close properties. The clustering method has some types, and, however, a method of classifying the collected data into a corresponding number of clusters to the properties of the collected data is more desirable than a method of classifying the collected data into a fixed number of clusters in the embodiment 1. In a processing example that follows, a determining subject such as the abnormality detection unit 2 quantitatively determines closeness of the property, and hence a distance value from a centroid is calculated.

An X-means is exemplified as a technique of properly determining a number of post-segmenting clusters. The X-means is the technique to which a K-means of classifying the collected data into a K-number of clusters is extended. The X-means recursively iterates the K-means till an indicator, instanced by Bayesian Information Criterion (BIC), for evaluating model selection satisfies a predetermined condition. The Bayesian Information Criterion is the indicator for indicating goodness-of-fit to measurement data of a generated model when generating the model for statistically describing the measurement data. The indicator for evaluating the model selection is defined by a number of parameters for generating the model, a size of samples, or a number of pieces of observed data and other equivalent numeric values.

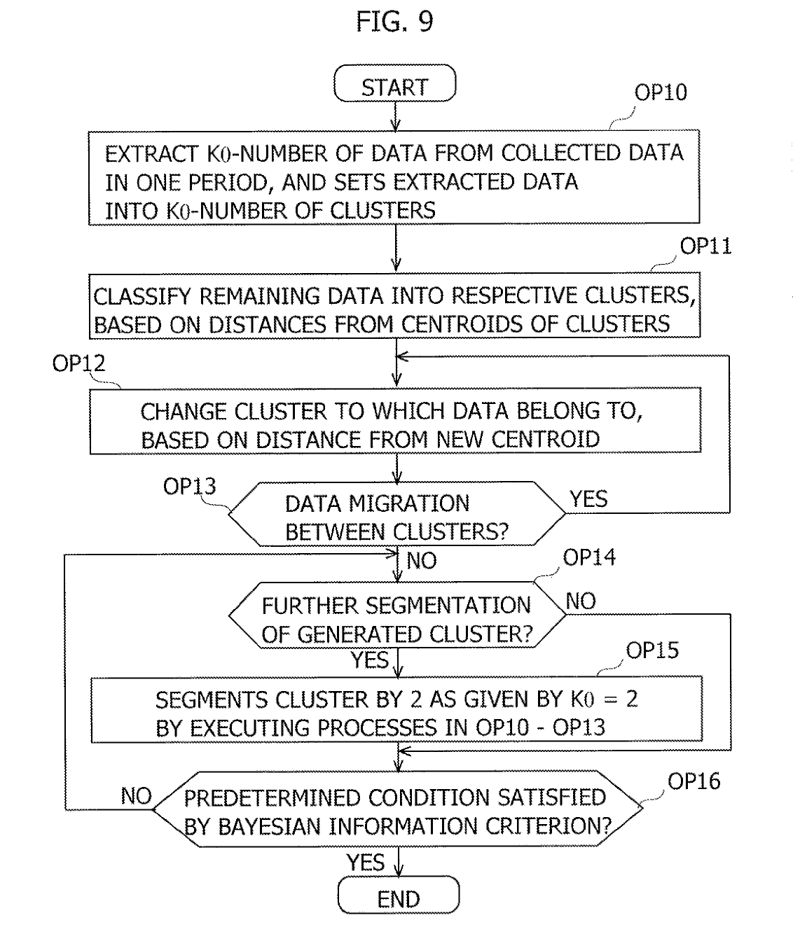

FIG. 9 is a flowchart illustrating an example of a classification process of the collected data by the X-means. A start of the classification process depicted in FIG. 9 is triggered by, e.g., an elapse of the state model update period. Note that a subject of the classification process is the processor 11 performing as an abnormality detection unit 2 or the hardware circuit performing as the abnormality detection unit 2, depending on the running of the abnormality detection program. The following description of the flowchart is based on an assumption that the subject of the classification process is the abnormality detection unit 2.

In OP10, the abnormality detection unit 2 extracts a k₀-number of data from the collected data in the determination target period, and classifies the extracted data into a k₀-number of clusters. In OP11, the abnormality detection unit 2 classifies the remaining data into the respective clusters, based on distances from centroids of the clusters. The centroid of the cluster may also be set as an average value of the data contained in the cluster.

In OP12, the abnormality detection unit 2 obtains new centroids after classifying the remaining data. The abnormality detection unit 2 changes the cluster to which the data belong to, based on the distance from the new centroid. In OP13, the abnormality detection unit 2 determines whether the data migrate between the clusters in the process of OP12. When the data migrate between the clusters (OP13: Yes), the processing loops back to OP12. Whereas when the data do not migrate between the clusters (OP13: No), the processing advances to OP14.

In processes of OP14 through OP16, the abnormality detection unit 2 iterates the segmentation of the clusters generated by the segmentation till the Bayesian Information Criterion satisfies the predetermined condition. Note that the criterion for evaluating the model selection may also be other types of information criteria without being limited to the Bayesian Information Criterion.

In OP14, the abnormality detection unit 2 determines whether to further segment the clusters generated in the processes of OP10 through OP13, based on the values of the Bayesian Information Criterion. When further segmenting the clusters (OP14: Yes), the processing advances to OP15. Whereas when not further segmenting the clusters (OP14: No), the processing advances to OP16.

In OP15, the abnormality detection unit 2 segments the segmentation target cluster by 2 as given by k₀=2 in the way of executing the processes in OP10 through OP13. In OP16, the abnormality detection unit 2 determines whether the Bayesian Information Criterion satisfies the predetermined condition. When the Bayesian Information Criterion satisfies the predetermined condition (OP16: Yes), the classification process in FIG. 9 comes to an end. Whereas when the Bayesian Information Criterion does not satisfy the predetermined condition (OP16: No), the processing loops back to OP14.

The collected data collected in OP10 in the determination target period are one example of “data about the predetermined item per segment in a determination target period. The Bayesian Information Criterion is one example of an “indicator for evaluating a segmented state”.

The processes in OP10 and OP11 are one example of a process of “classifying the data acquired by the first acquiring into a predetermined number of groups. The processes in OP12 and OP13 are one example of a process of “changing group to which each piece of data belongs on the basis of a difference from an average value of data belonging to each of the groups. The process in OP14 is one example of “second determining whether to further segment each of the predetermined number of groups on the basis of a value of an indicator for evaluating a segmented state. The processes in OP15 and OP16 are one example of a process of “iterating segmentation till the value of the indicator for evaluating the segmented state fulfills a predetermined condition.

The X-means illustrated in FIG. 9 is nothing but one example, and the method of classifying the collected data into a plurality of datasets may also take a variety of modified examples of the X-means. For example, a known method is a method of merging inadequate segmentations in the iterative segmentations of the clusters. It may be sufficient that the method of classifying the collected data into the plurality of datasets is simply a method of classifying the collected data into an adequate number of clusters, corresponding to the properties of the data, without being limited to the X-means.

<Generation of State Model>

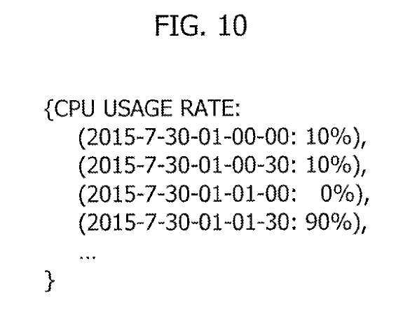

FIGS. 10 through 13 are explanatory diagrams of how the state model is generates. FIG. 10 is the diagram illustrating one example of a data structure of the collected data. FIG. 10 illustrates an example of indicating the data of the CPU usage rates measured at an interval of 30 sec of the data collecting segment in the state model update period starting from “1:30 am on 30th of July, 2015” in a certain processing apparatus 4.

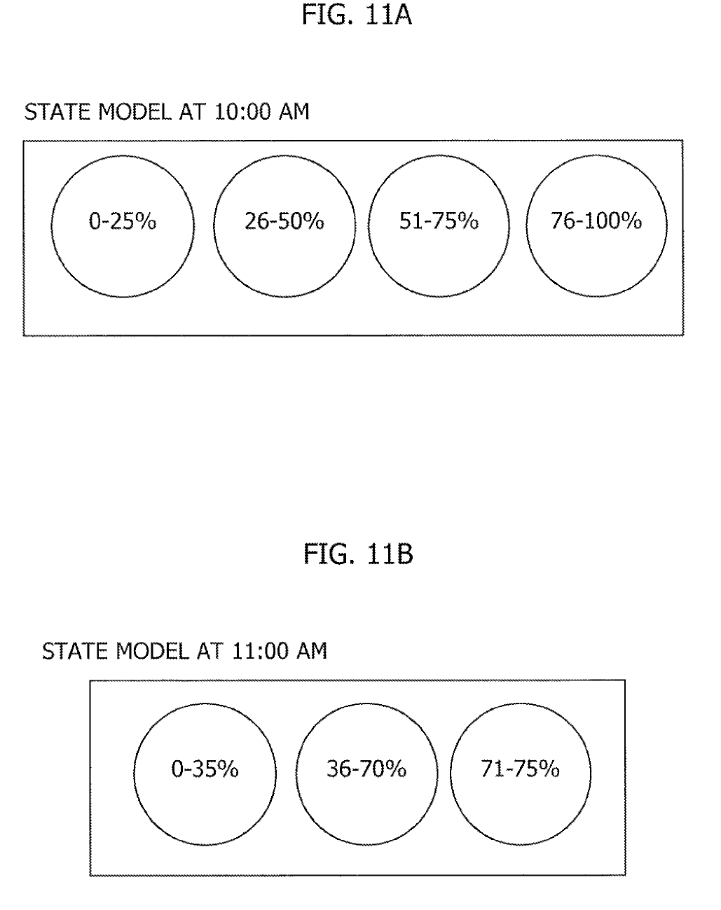

FIGS. 11A and 11B depict examples of the state model generated per update period by clustering based on the collected data. The data collected in each update period are classified into a corresponding number of groups to the properties instanced by a dispersion of the data. The group will hereinafter be also simply called the “state”. In the examples of FIGS. 11A and 11B, the state model update period is one hour. For example, the state model at 10:00 am is a state model generated from the data collected for one hour from 10:00 am to 11:00 am.

FIG. 11A is the diagram illustrating the example of the state model at 10:00 am. The data of the CPU usage rates collected in the period from 10:00 am to 11:00 am are classified into four states taking values of a 0-25% range, a 26-50% range, a 51-75% range and a 76-100% range as the CPU usage rates. Note that the data of the CPU usage rate is described as being indicated by an integer value.

FIG. 11B is the diagram illustrating the example of the state model at 11:00 am. The data of the CPU usage rates collected in the period from 11:00 am to 12:00 pm are classified into three states taking the values of a 0-35% range, a 36-70% range and a 71-100% range as the CPU usage rates.

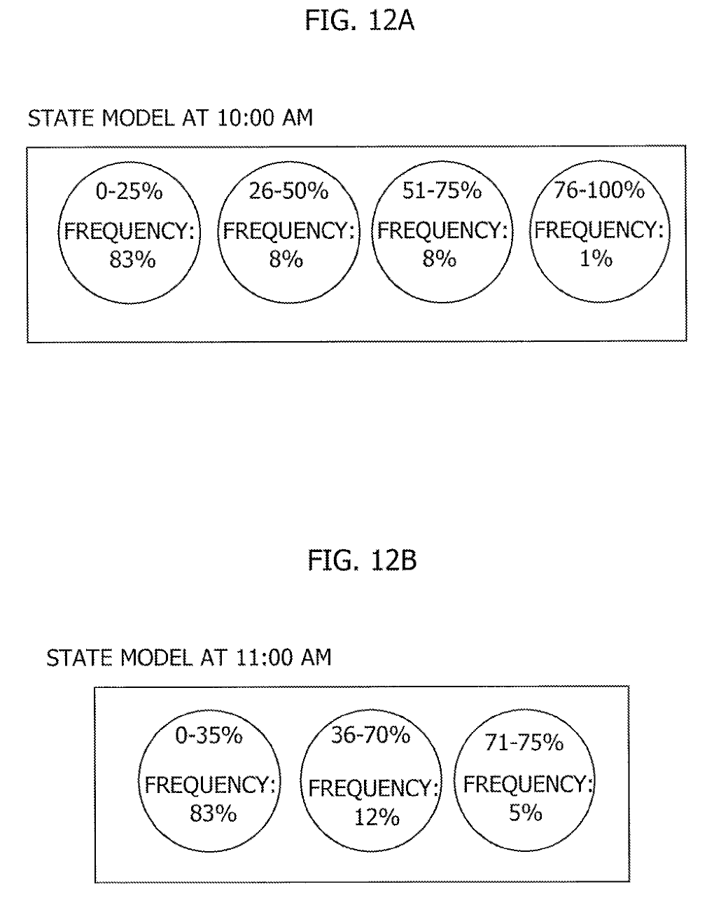

FIG. 12A is a diagram illustrating an example of the state model at 10:00 am, which includes the occurrence frequency. In the following discussion, the occurrence frequency of the data per state is to be a rate of the number of data belonging to the state concerned to the number of data collected in the respective data collecting segments contained in one state model update period. The occurrence frequency of the data per state will hereinafter be also simply called the “occurrence frequency of the state”.

In the example of FIG. 12A, when the state model update period at 10:00 am is equally segmented into 90 data collecting segments, 90-pieces of data are collected. In the collected data of the CPU usage rates, the number of data with the CPU usage rate being “0-25%” is assumed to be “75”. The number of data with the CPU usage rates being “26-50%”, “51-75%” and “76-100%” are assumed to be “7”, “7” and “1”, respectively. In this case, the occurrence frequency of the state, to which the data with the CPU usage rate being “0-25%” belong, is approximately 83% given by (75/90)×100. Similarly, the occurrence frequencies of the states, to which the data with the CPU usage rates being “26-50%”, “51-75%” and “76-100%” belong, are approximately 8%, 8% and 1%, respectively.

FIG. 12B is a diagram illustrating an example of the state model at 11:00 am, which contains the occurrence frequencies. In the example of FIG. 12B, when the state model update period at 11:00 am is equally segmented into 90 data collecting segments, 90-pieces of data are collected. In the collected data of the CPU usage rates, the number of data with the CPU usage rate being “0-35%” is assumed to be “75”. The number of data with the CPU usage rates being “36-70%” and “71-100%” are assumed to be “11” and “4”, respectively. In this case, the occurrence frequency of the state, to which the data with the CPU usage rate being “0-35%” belong, is approximately 83% given by (75/90)×100. Likewise, the occurrence frequencies of the states, to which the data with the CPU usage rates being “36-70%” and “71-100%” belong, are approximately 12% and 5%, respectively.

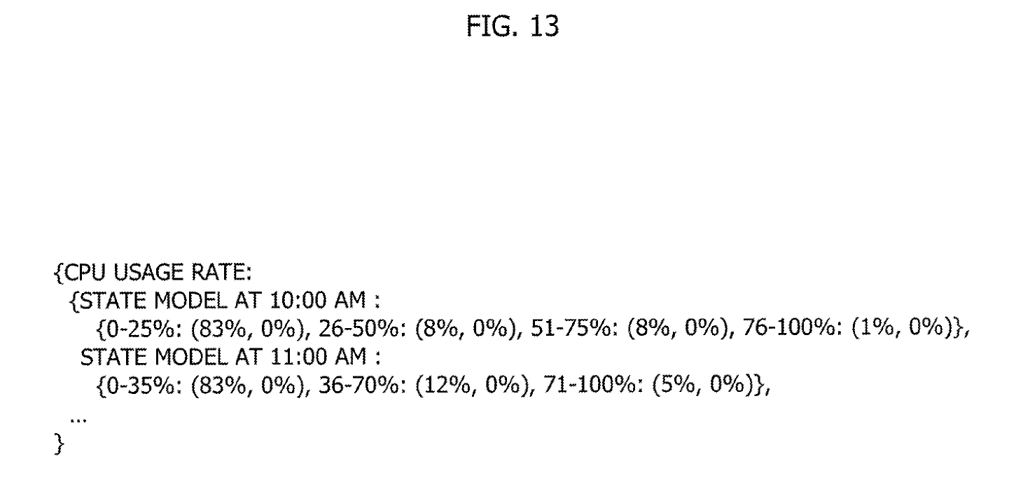

FIG. 13 is a diagram illustrating an example of the data structures of the state models. FIG. 13 depicts the data structures of the state models in FIGS. 12A and 12B. The data structure with respect to the occurrence frequency of each state expressed in a format given by “p-q %:(x %,y %)”. An element “p-q %” represents a state containing the data with the CPU usage rate being “p-q %”. A first element “x %” in parentheses represents the occurrence frequency of the state of “p-q %”. A second element “y %” in the parentheses represents an occurrence frequency counter employed when determining the abnormality. When the data are collected per data collecting segment of the determination target period, the occurrence frequency of the state, to which the collected data belong, is calculated, and the calculated occurrence frequency is set in the counter y %. The counter y % is initialized to 0% when generating the state model. Specifically, in FIG. 13, the state with the CPU usage rate being “0-25%” in the state model at 10:00 am is expressed by “0-25%:(83%,0%)”, where “83%” is the occurrence frequency.

<Abnormality Determination>

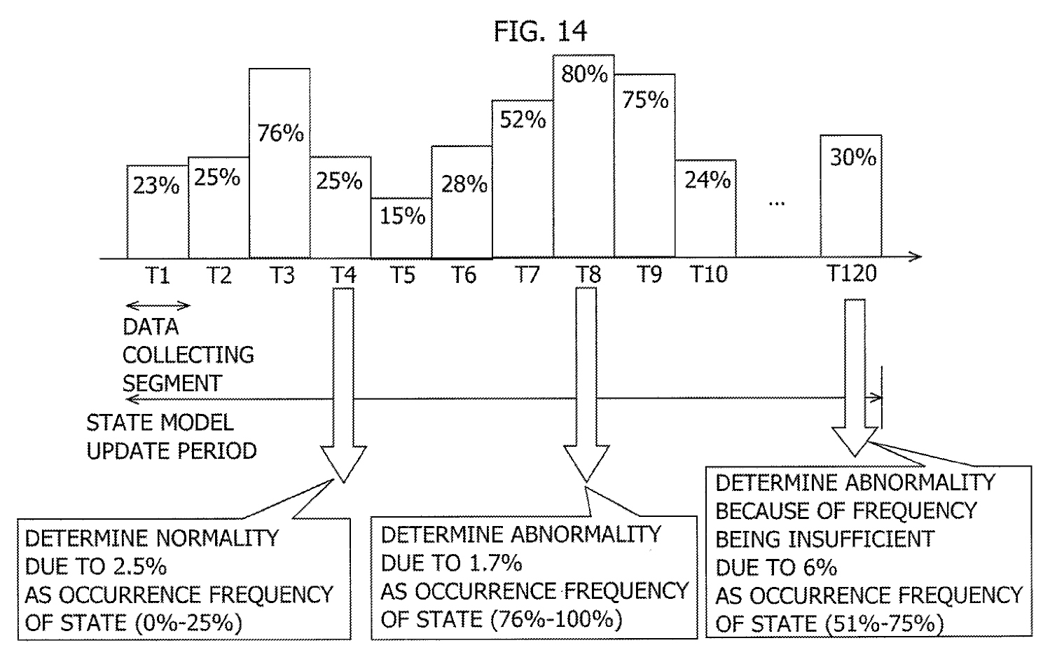

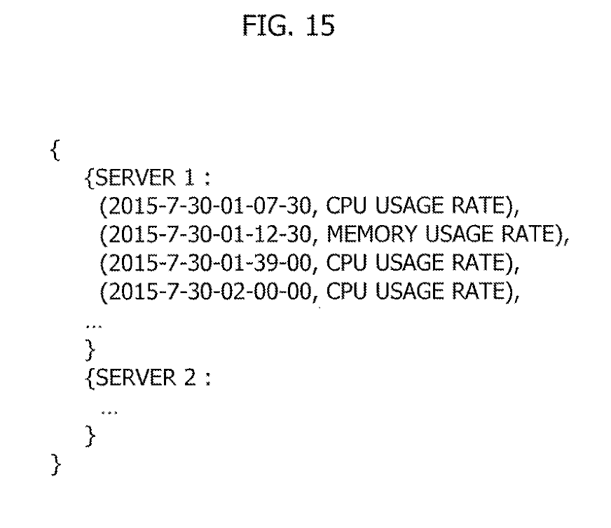

FIGS. 14 and 15 are explanatory diagrams of how the abnormality is determined. FIG. 14 illustrates an example of how the abnormality is determined in the state model update period. In FIG. 14, the determination about whether the abnormality occurs is made based on a comparison with the state model at 10:00 am illustrated in FIG. 12A.

In FIG. 14, the state model update period is equally segmented into 120 data collecting segments “T₁-T₁₂₀^{”}. The abnormality detection unit 2 determines whether the abnormality occurs by calculating the occurrence frequency of the state to which the collected data belong per data collecting segment. The abnormality detection unit 2 determines the abnormality when the calculated occurrence frequency exceeds the occurrence frequency of the corresponding state in the state model.

The determination about whether abnormal or not is not limited to the determination about whether in excess of the occurrence frequency of the corresponding state in the state model. The abnormality detection unit 2 may determine the abnormality, for instance, when becoming equal to or larger by ((occurrence frequency of corresponding state in state model)+x) % than a predetermined threshold value x. The abnormality detection unit 2 may also determine the abnormality when becoming equal to or larger by {(occurrence frequency of corresponding state in state model)×(1+y/100)}% than a predetermined threshold value y. The threshold values x, y can be set in a way that takes account of, e.g., the number of data collecting segments or the properties instanced by the dispersion of the collected data.

It is also determined whether the abnormality occurs when the state model update period expires. This is because the determination about whether the occurrence frequency is under the allowable range is made at the time when the state model update period expires. At the time point of the expiration of the state model update period, the abnormality detection unit 2 compares the occurrence frequency of each state with the occurrence frequency of each corresponding state in the state model. The abnormality detection unit 2 determines the abnormality when there are one or more such states that the occurrence frequency of each state at the time point of the expiration of the state model update period is lower than the occurrence frequency of each corresponding state in the state model.

The determination about whether the occurrence frequency of the state is lower than the occurrence frequency of the corresponding state in the state model may also be made based on whether equal to or smaller by ((occurrence frequency of corresponding state in state model)−x) % than, e.g., the predetermined threshold value x. The determination about whether the occurrence frequency of the state is lower than the occurrence frequency of the corresponding state in the state model may further be made based on whether equal to or smaller by {(occurrence frequency of corresponding state in state model)×(1−y/100)}% than the predetermined threshold value y. The threshold values x, y can be set by taking account of, e.g., the number of data collecting segments or the properties instanced by the dispersion of the collected data.

The following is a description of a specific example of how the abnormality is determined in FIG. 14. In FIG. 14, it is determined, from the comparison with the state model at 10:00 am illustrated in FIG. 12A, whether the abnormality occurs. Pieces of data T₁, T₂ and T₄ are the data belonging to the state containing the data having the rate of “0%-25%” at the time after collecting the data T₄, and it follows that these data occur at least three times in the data collecting segments T₁-T₁₂₀. Accordingly, the occurrence frequency at the time after collecting the data T₄ is 2.5% calculated such as (3/120)×100. In the state model of FIG. 12A, the occurrence frequency of the state containing the data having the rate of “0%-25%” is 83%, and the occurrence frequency after collecting the data T₄ is lower than 83%, whereby a normality determination is made.

Pieces of data T₃ and T₈ are the data belonging to the state containing the data having the rate of “76%-100%” at the time after collecting the data T₈, and it follows that these data occur at least twice in the data collecting segments T₁-T₁₂₀. Hence, the occurrence frequency at the time after collecting the data T₈ is approximately 1.7% calculated such as (2/120)×100. In the state model of FIG. 12A, the occurrence frequency of the state containing the data having the rate of “76%-100%” is 1%, and the occurrence frequency after collecting the data T₈ is equal to or larger than 1%, thereby determining the abnormality.

After collecting the data T₁₂₀, i.e., at the time after the state model update period expires, the occurrence frequency of the state containing the data having the rate of 51%-75% is assumed to be 6%. In the state model of FIG. 12A, the occurrence frequency of the state containing the data having the rate of “51%-75%” is 8%, and the occurrence frequency after the expiration of the state model update period is lower than 8%, thereby determining the abnormality.

Information related to the detected abnormality is stored in the data store 3. The information related to the detected abnormality, which is stored in the data store 3, is outputted in a predetermined format to the output device 15 and notified to the user. FIG. 15 is a diagram illustrating an example of a data structure of the information related to the detected abnormality.

The example in FIG. 15 indicates the information related to the detected abnormality per resource instanced by the server 1 and the server 2 in the abnormality detection target system. It is displayed in the server 1 that the abnormality with respect to the CPU usage rate is detected at 01:07:30, 01:39:00 and 02:00:00 on 30th of July, 2015. It is also displayed in the server 1 that the abnormality with respect to the memory usage rate is detected at 01:12:30 on 30th of July, 2015.

Note that the data structure of the information related to the detected abnormality is not limited to this structure. The data structure of the information related to the detected abnormality may contain such items of information as the CPU usage rate at the detection time of the abnormality, the occurrence frequency at the detection time of the abnormality and the occurrence frequency in the normal state.

<Processing Flow>

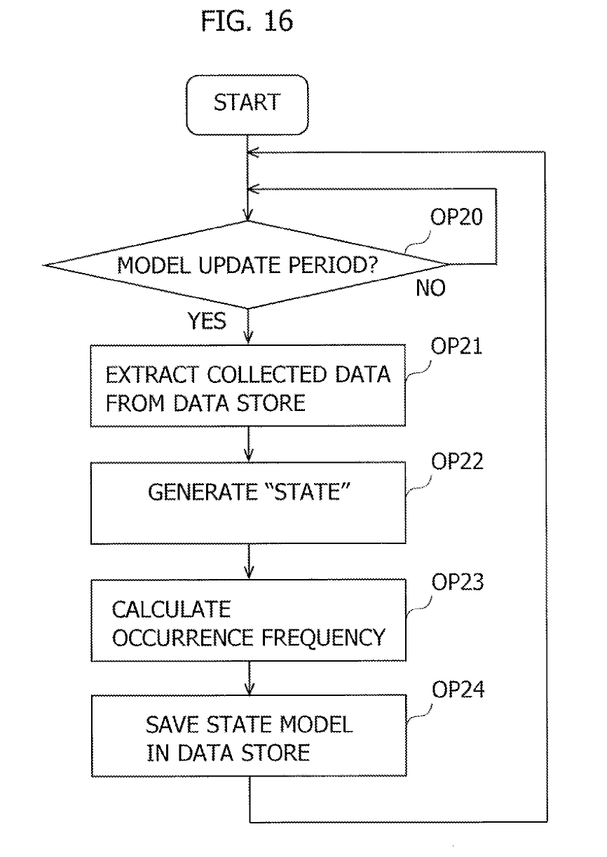

FIG. 16 is a flowchart illustrating an example of a process of generating the state model. The state model is generated at timing such as when receiving an instruction from the user upon starting the operation of the abnormality detection target system and other equivalent targets or changing the variety of settings thereof. A start of processes illustrated in FIG. 16 is triggered by, e.g., receiving a state model generating instruction from the user. It does not therefore mean that the generation of the state model is limited to the specified timing.

In OP20, the abnormality detection unit 2 determines whether the present time point is the time point when the state model update period expires. A length of the state model update period may be defined beforehand in the data store 3, and may also be designated by the user when starting the processes illustrated in FIG. 16. The time point when the state model update period expires is such a time point that the time elapsed from the time point of starting the processes illustrated in FIG. 16 reaches an integral multiple of the length of the state model update period. The present time point is the time point when the state model update period expires (OP20: Yes), in which case the processing advances to OP21. The present time point is not the time point when the state model update period expires (OP20: No), in which case the abnormality detection unit 2 iterates OP20 at a predetermined interval till reaching the expiration of the state model update period.

In OP21, the abnormality detection unit 2 extracts the collected data in the expired state model update period from the data store 3. The data collection unit 1 periodically collects, from the processing apparatus 4, the data representing the settings or the states of the resources per data collecting segment obtained by segmenting the state model update period into the plurality of segments, and stores the collected data in the data store 3. It may be sufficient that the abnormality detection unit 2 extracts, from the data store 3, the collected data of the processing apparatus 4 as the abnormality detection target apparatus in the expired state model update period. In OP22, the abnormality detection unit 2 generates a plurality of states by classifying the extracted data.

In OP23, the abnormality detection unit 2 calculates the occurrence frequency per state. In OP24, the abnormality detection unit 2 stores the plurality of states generated in OP22 as one state model in the data store 3. The abnormality detection unit 2 stores the occurrence frequency per state, which is calculated in OP23, together with the plurality of states in the data store 3. The abnormality detection unit 2 further stores the date/time information and the hour information about the start and the end of the state model update period in the data store 3. The processing loops back to OP20, and the state model generation process iterated in every state model update period. The generation of the state model is finished upon, e.g., the user's instruction.

The process in OP21 is one example of “first acquiring data about a predetermined item of a processing apparatus per segment from the processing apparatus, the segment being obtained by segmenting one period into a plurality of segments, the processing apparatus iteratively executing processes”. The process in OP22 is one example of a process of “first classifying the data acquired by the first acquiring into a plurality of groups by a predetermined classification criterion”. The processes in OP23 and OP24 are one example of a process of “storing an occurrence frequency of the data in the one period per group”.

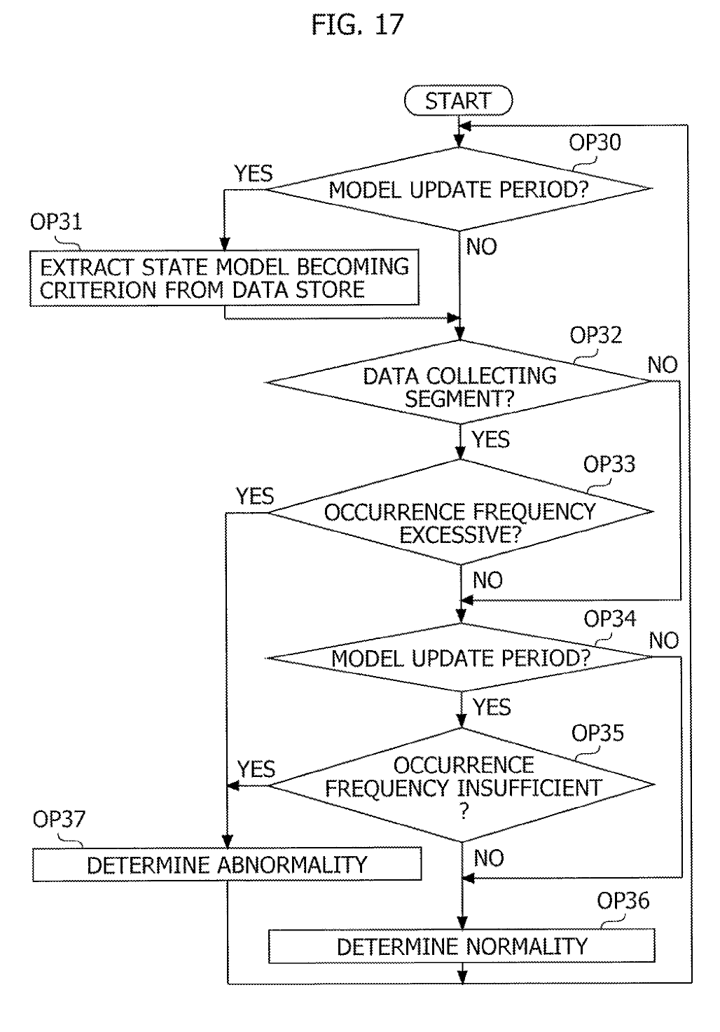

FIG. 17 is a flowchart illustrating an example of the abnormality determination process in the embodiment 1. A start of processes illustrated in FIG. 17 is triggered upon receiving, e.g., an instruction to detect the abnormality of the abnormality detection target processing apparatus 4 from the user. In OP30, the abnormality detection unit 2 determines whether the state model update period reaches a time point of its expiration. When the state model update period reaches the time point of its expiration (OP30: Yes), the processing advances to OP31. Whereas when the state model update period does not yet reach the time point of its expiration (OP30: No), the processing advances to OP32.

In OP31, the abnormality detection unit 2 extracts the state model satisfying the predetermined condition as a state model becoming a criterion for determining the abnormality from the data store 3. The state model becoming the criterion is the state model of the normal pattern compared with the occurrence frequency per state of the data collected in the determination target period in the abnormality determination process in the determination target period. The abnormality detection unit 2 can extract the state model generated from, e.g., the data collected on the same day of week and at the same hour as those of the determination target period by way of the state model satisfying the predetermined condition.

In OP32, the abnormality detection unit 2 determines whether the present time point is a time point when the data collecting segment expires. The present time point is the time point when the data collecting segment expires (OP32: Yes), in which case the processing advances to OP33. The present time point is not the time point when the data collecting segment expires (OP32: No), in which case the processing advances to OP34.

In OP33, the abnormality detection unit 2 determines whether the occurrence frequency is excessive in comparison with the occurrence frequency of the corresponding state of the state model extracted in OP31. “The occurrence frequency being excessive” connotes a case of determining the abnormality because of being higher above the allowable range than the occurrence frequency of the state model. When the occurrence frequency is excessive (OP33: Yes), the processing advances to OP37. Whereas when the occurrence frequency is not excessive (OP33: No), the processing advances to OP34.

Note that the occurrence frequency is the occurrence frequency of the state containing the data of the expired data collecting segment, and is calculated by the abnormality detection unit 2. The calculated occurrence frequency is retained in the data store 3 as the occurrence frequency at the present time point of the state concerned. In the subsequent processes also, the abnormality detection unit 2 is to retain the calculated occurrence frequencies in the data store 3.

In OP34, the abnormality detection unit 2 determines whether the present time point is the time point of the expiration of the state model update period. When the present time point is the time point of the expiration of the state model update period (OP34: Yes), the processing advances to OP35. Whereas when the present time point is not the time point of the expiration of the state model update period (OP34: No), the processing advances to OP36.

In OP35, the abnormality detection unit 2, when not executing the process in OP33, collects the data in the data collecting segment at the time point of the expiration of the state model update period, and calculates the occurrence frequency of the state containing the collected data. The abnormality detection unit 2 compares the occurrence frequency of each state with the occurrence frequency of the corresponding state of the state model extracted in OP31, thereby determining whether the occurrence frequency is insufficient. “The occurrence frequency being insufficient” connotes a case of determining the abnormality because of being lower under the allowable range than the occurrence frequency of the state model. When there exist one or more states with the occurrence frequency being insufficient (OP35: Yes) the processing advances to OP37. Whereas when there is none of the state with the occurrence frequency being insufficient (OP35: No), the processing advances to OP36.

In OP36, the abnormality detection unit 2 determines the normality, and the processing loops back to OP30. In OP37, the abnormality detection unit 2 determines the abnormality, and the processing loops back to OP30. The determination results in OP36 and OP37 are retained in the data store 3. When the processing loops back to OP30, the abnormality determination process is iterated. The abnormality determination process illustrated in FIG. 17 is finished by, e.g., the user's instruction.

The processes in OP33 and OP35 are one example of a process of “second acquiring data about the predetermined item per segment in a determination target period, the determination target period having a same length as a length of the one period and first determining existence of abnormality in the processing apparatus when occurrence frequency of data in the determination target period per group deviates from an allowable range based on the occurrence frequency of the data in the one period”.

<Operational Effect of Embodiment 1>

The abnormality detection apparatus 10 classifies the collected data in the state model update period into a proper number of groups corresponding to the properties of the data, and calculates the occurrence frequency of the data belonging to each group, thereby generating the state model based on the occurrence frequency. The calculated occurrence frequency is set as the threshold value for determining whether abnormal or not, whereby the state model adequate to the collected data taking the discrete values is generated. The abnormality detection apparatus 10 compares the occurrence frequency of each group in the determination target period with the occurrence frequency in the state model based on the occurrence frequency. The abnormality detection apparatus 10 is thereby enabled to detect the abnormality of the processing apparatus 4 by iteratively executing the processes more accurately than in the case of detecting the abnormality through the comparison with the normal mode based on the average value.

The abnormality detection apparatus 10 implements the abnormality determination in every determination target period as to whether the occurrence frequency of the data in the determination target period exceeds an upper limit value of the allowable range of the occurrence frequency in the state model. The abnormality detection apparatus 10 is thereby enabled to detect the abnormality in real time per segment.

When the determination target period expires, the abnormality detection apparatus 10 implements the abnormality determination about whether the occurrence frequency of the data in the determination target period of one or more groups in the plurality of groups decreases under a lower limit value of the allowable range of the occurrence frequency in the state model. The abnormality detection apparatus 10 is thereby enabled to detect the abnormality also when the occurrence frequency becomes insufficient.

The abnormality detection apparatus 10 classifies the data acquired in one period into a predetermined number of groups, and changes the groups to which the respective data belong, based on a difference from the average value of the data belonging to the respective groups. The abnormality detection apparatus 10 determines, based on a value of the indicator for evaluating the segmented state, whether to further segment each of the predetermined number of groups, and iterates the segmentation till the value of the indicator for evaluating the segmented state fulfills the predetermined condition with respect to the group determined to be segmented. The abnormality detection apparatus 10 is thereby enabled to generate the state model representing the properties instanced by the dispersion of the data by classifying the collected data into the corresponding number of groups to the properties of the data on the occasion of generating the state model.

### Embodiment 2

In the abnormality detection process of the embodiment 1, the abnormality detection apparatus 10 sets the state model satisfying the predetermined condition as the state model becoming the criterion for determining the abnormality. On the other hand, according to an embodiment 2, the state model becoming the criterion is selected based on a degree of similarity between the state models, which are common in terms of a time zone, a day of week and other equivalent items, from the plurality of past state models in the abnormality determination process.

The degree of similarity (which is also termed the similarity degree) may be defined based on a total sum of absolute values of differences of the observed values between the state models by, e.g., rearranging the data collected in the state model update periods corresponding to the respective state models in an ascending sequence or descending sequence on the basis of the observed values of the collected data. In the following discussion, according to the embodiment 2, the total sum of the absolute values of the differences will be simply called the “total sum of the differences”. In this case, the similarity degree is higher as the total sum of the differences is smaller, and is lower as the total sum of the differences is larger. The similarity degree may also be defined based on the number of states classified by clustering and the difference between the state models with respect to the range of the data belonging to the respective states.

The hardware configuration and the components of the abnormality detection apparatus 10 in the embodiment 2 are the same as those in the embodiment 1, and hence their explanations are omitted. The method of generating the state mode in the embodiment 2 is the same as in the embodiment 1, and therefore its explanation is also omitted.

<Selection of State Model>

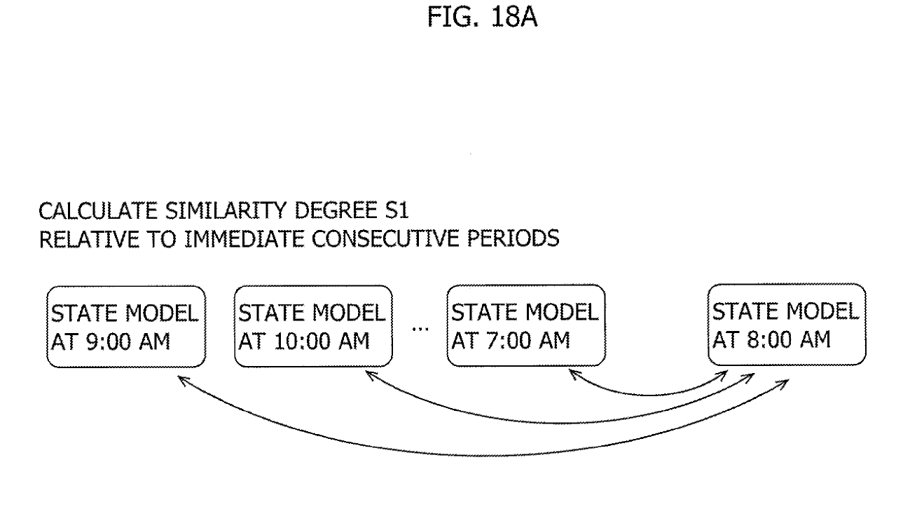

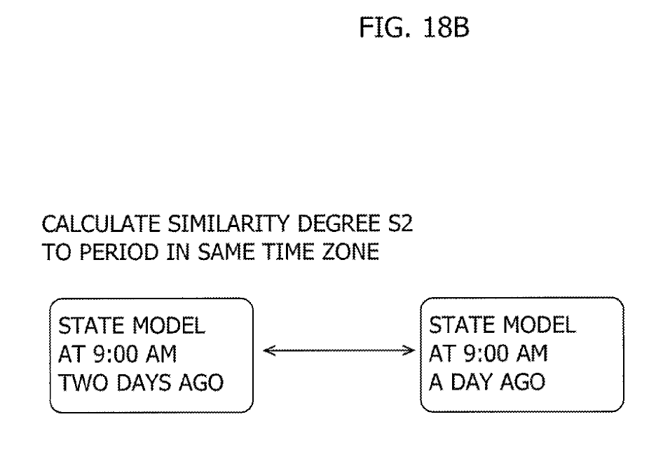

FIGS. 18A and 18B are diagrams each illustrating an example of how the state model is selected. Herein, the state model update period is assumed to be one hour. An example of selecting the state model becoming the criterion for the period at 9:00 am, is described. The method of selecting the state model is not limited to methods depicted in FIGS. 18A and 18B. The method of selecting the state model is not the method focused on the time zone as in FIGS. 18A and 18B, but can be also a selection method focused on identities of a day of week and a month.

FIG. 18A illustrates an example in which the abnormality detection apparatus 10 selects the state model becoming the criterion from the state models of immediate consecutive periods. Herein, the present time is assumed to be 9:00 am of today, and the state model becoming the criterion is selected from the state models of the immediate consecutive periods. The abnormality detection apparatus 10 obtains the similarity degrees between the state model at 8:00 am of today and the respective state models ranging from 7:00 am an hour ago up to 9:00 am one day ago by tracing back from 8:00 am of today, and specifies the state model exhibiting the highest similarity degree. The similarity degree to the specified state model is designated by S1. The abnormality detection apparatus 10 can select the state model of the period next to the period exhibiting the most similarity to the model at 8:00 am as a state model with respect to the period at 9:00 am, which will be observed from now on. Supposing that the period of the state model exhibiting the most similarity to the model at 8:00 am is, e.g., 11:00 am, the model at 12:00 pm is selected as the state model with respect to the period of 9:00 am.

FIG. 18B illustrates an example of how the abnormality detection apparatus 10 selects the state model becoming the criterion from the state models of the periods in the same time zone. The abnormality detection apparatus 10 obtains a similarity degree S2 to each of the state model at 9:00 am one day ago and the state model at 9:00 am two days ago by tracing back from the present time. When the similarity degree S2 is higher than the similarity degree S1 obtained in FIG. 18A, the abnormality detection apparatus 10 can select the state model at 9:00 am one day ago as the state model with respect to the period of 9:00 am.

<Processing Flow>

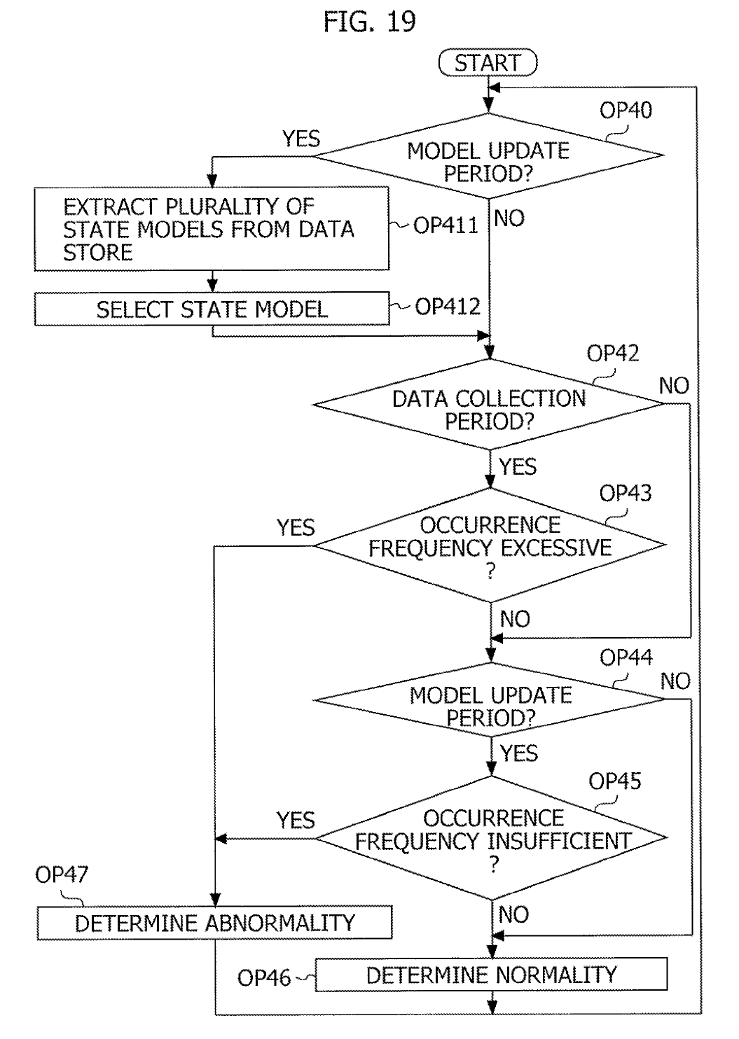

The example of the process of generating the state model in the embodiment 2 is the same as in the embodiment 1, and hence its explanation is omitted. FIG. 19 is a flowchart illustrating an example of the abnormality determination process in the embodiment 2. The abnormality determination process in the embodiment 2 is the same as in the embodiment 1 except the process of selecting the state model. To be specific, the processes of OP40, OP42 through OP47 in FIG. 19 are the same as the processes of OP30, OP32 through OP37 in FIG. 17, and therefore the explanations of the common portions are omitted.

In OP40, when reaching the time point of the expiration of the state model update period (OP40: Yes), the processing advances to OP411. Whereas when not reaching the time point of the expiration of the state model update period (OP40: No), the processing advances to OP42.

In OP411, the abnormality detection unit 2 extracts the plurality of state models from the data store 3, corresponding to the selection method of the state model. In OP412, the abnormality detection unit 2 selects the state model becoming the criterion for determining the abnormality. The processing advances to OP42. The subsequent processes are the same as in the embodiment 1.

OP412 is one example of a process of “selecting the normal pattern satisfying a predetermined condition from the plurality of stored normal patterns”. The processes in OP43 and OP45 are one example of a process of “determining the existence of the abnormality in the processing apparatus when the occurrence frequency of the data acquired by the second acquiring per group deviates from an allowable range based on the selected normal pattern”.

<Operational Effect of Embodiment 2>

The abnormality detection apparatus 10 classifies, similarly to the embodiment 1, the collected data in the state model update period into the corresponding number of groups to the properties of the data, and thus generates the state model. In the embodiment 2, the normal pattern satisfying the predetermined condition is selected as the state model becoming the criterion from the plurality of past state models. The proper state model corresponding to the properties of the data is thereby selected, and the abnormality detection apparatus 10 can detect the abnormality of the processing apparatus 4 iteratively executing the processes more accurately than in the case of detecting the abnormality through the comparison with the specified state model.

The abnormality detection apparatus 10 selects the state model becoming the criterion, based on the similarity degree between the state models, which are common in terms of the time zone, the day of week and other equivalent items as the predetermined conditions. In this case, the more proper state model for the collected data taking the periodic values is selected, and the abnormality detection apparatus 10 can detect further accurately the abnormality of the processing apparatus 4 iteratively executing the processes corresponding to the time zone, the day of week and other equivalent items.

For example, the abnormality detection apparatus 10 selects, as the state model becoming the criterion, the normal pattern of the period next to the normal pattern having the most similarity to the normal pattern of the immediate period from the normal patterns of the respective periods until a predetermined period of time ago including the plurality of periods. The abnormality detection apparatus 10 is thereby enabled to select the proper state model predicted from the immediate period.

The abnormality detection apparatus 10 compares the similarity degree (S2 in FIG. 18B) between the two consecutive past normal patterns in the past normal patterns stored at an interval of a predetermined period of time with the similarity degree (S1 in FIG. 18A) between the normal pattern of the immediate period and the normal pattern having the most similarity to the normal pattern of the immediate period in the normal patterns within the predetermined period of time. The abnormality detection apparatus 10 selects the latest normal pattern stored at the interval of the predetermined period of time when the similarity degree S2 is higher than the similarity degree S1, and is thereby enabled to select the proper state models, which are common in terms of the time zone, the day of week and other equivalent items.

The abnormality detection apparatus 10 rearranges the data acquired in the state model update period in the ascending sequence or descending sequence, and determines that the similarity degree is higher as the total sum of the differences of the data per data collecting segment is smaller. The abnormality detection apparatus 10 is thereby enabled to select the more proper state model by calculating the similarity degree corresponding to the properties instanced by the dispersion of the data in the state model update period.

### Embodiment 3

In the embodiments 1 and 2, the abnormality detection apparatus 10 determines whether abnormal or not by comparing the occurrence frequency per state in the determination target period with the occurrence frequency in the state model. In an embodiment 3, the abnormality detection apparatus 10 determines whether abnormal or not by comparing, in addition the occurrence frequency, a transition rate between the states in the determination target period with an allowable range of the transition rate in the state model.

The hardware configuration and the processing configuration of the abnormality detection apparatus 10 in the embodiment 3 are the same as in the embodiment 1, and hence their explanations are omitted. A process of selecting the state model in the embodiment 3 is the same as in the embodiment 2, and therefore its explanation is omitted.

<Generation of State Model>

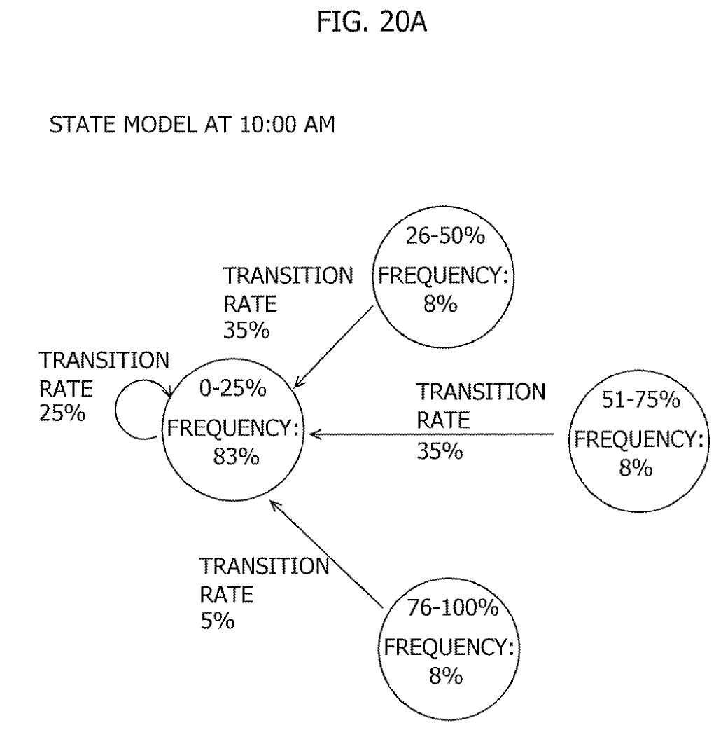

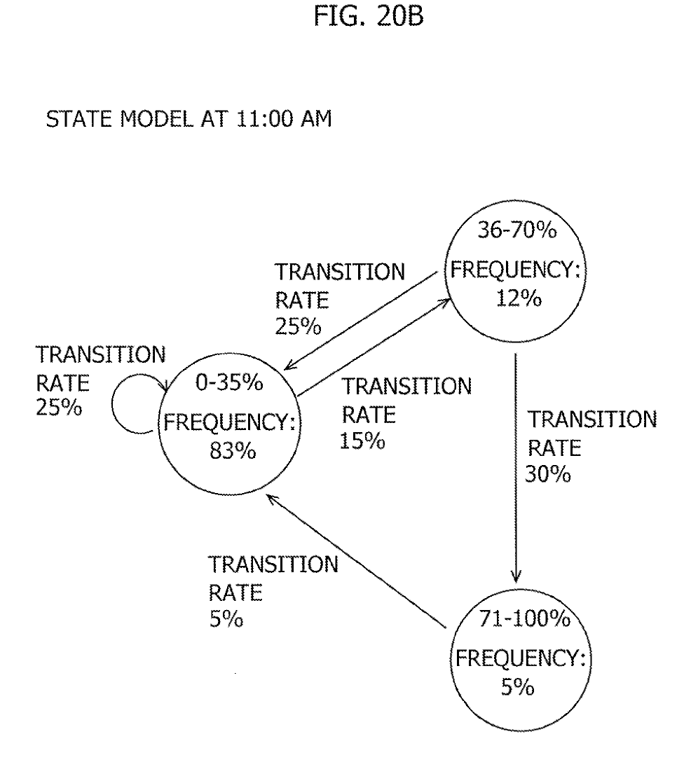

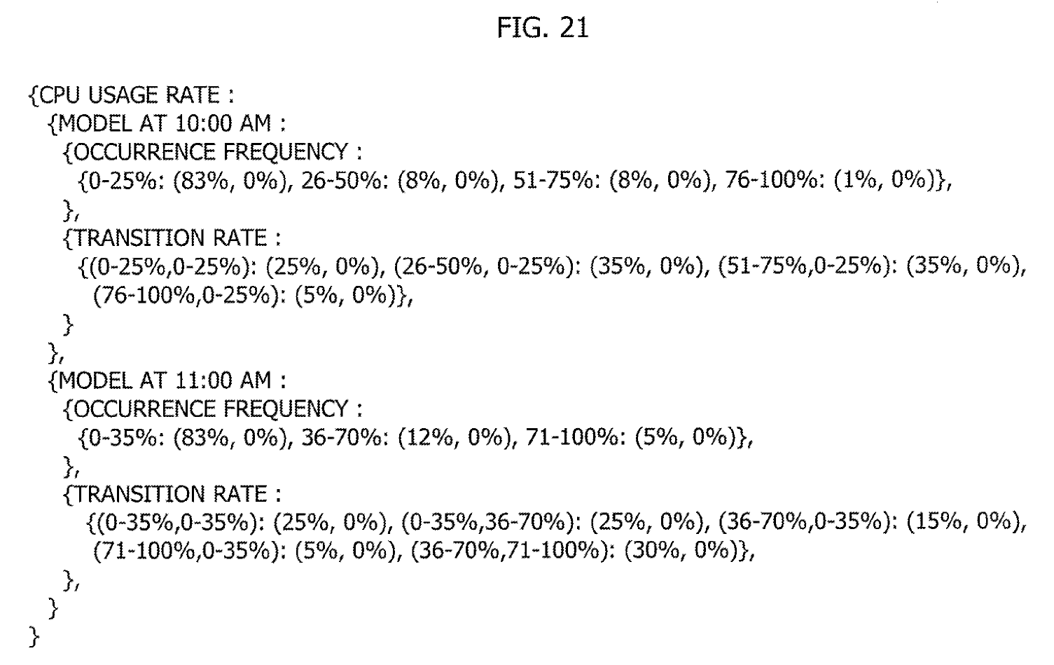

FIGS. 20A through 21 are explanatory diagrams of how the state model is generated in the embodiment 3. The state model in the embodiment 3 contains information of the transition rate from one state to another state in addition to the occurrence frequency of each state.

FIG. 20A is a diagram illustrating an example of the state model at 10:00 am, which contains the transition rate. In the following description, the transition rate between the states is calculated as a rate of a count of how many times the transition occurs between the specified states to a count of the state transitions in the state model update period. The state of 0-25% as the CPU usage rate will hereinafter be expressed by the state (0-25%).

An example in FIG. 20A represents that the transition rate from the state (0-25%) to the state (0-25%) is 25%. Similarly, the transition rates from the state (0-25%) to the state (0-25%), from a state (51-75%) to the state (0-25%) and from a state (76-100%) to the state (0-25%) are 35%, 35% and 5%, respectively. Note that the occurrence frequencies in the respective states are the same as in FIG. 12A.

FIG. 20B is a diagram illustrating an example of the state model at 11:00 am including the transition rates. The example in FIG. 20B represents that the transition rate from the state (0-35%) to the state (0-35%) is 25%. Similarly, the transition rates from the state (0-35%) to the state (36-70%), from the state (36-70%) to the state (0-35%), from a state (71-100%) to the state (0-35%) and from the state (36-70%) to the state (71-100%) are 15%, 25%, 5% and 30%, respectively. Note that the occurrence frequencies in the respective states are the same as in FIG. 12B.

FIG. 21 is a diagram illustrating an example of data structures of the state models in the embodiment 3. FIG. 21 depicts the data structures of the state models in FIGS. 20A and 20B. The data structure of the occurrence frequency is the same as in FIG. 13, and hence its explanation is omitted.

A data structure with respect to the transition rate between the states is expressed in a format given by “(p1-q1%,p2-q2%):(s %,t %)”. A value (p1-q1%,p2-q2%) given in first parentheses indicates a state transition from a state (p1-q1%) to a state (p2-q2%). A first element s % given in second parentheses is a transition rate from the state (p1-q1%) to the state (p2-q2%). A second element t % given in the second parentheses is a transition rate counter used when determining the abnormality. In the determination target period, the transition between the states before and after the segment is calculated per data collecting segment, and the calculated transition rate is set in the counter t %. The counter t % is initialized to 0% when generating the state model. Specifically, in FIG. 21, the transition from the state (0-25%) to the state (0-25%) in the state mode at 10:00 am has the transition rate “25%” and is expressed by “(0-25%,0-25%):(25%,0%)”.

<Abnormality Determination>

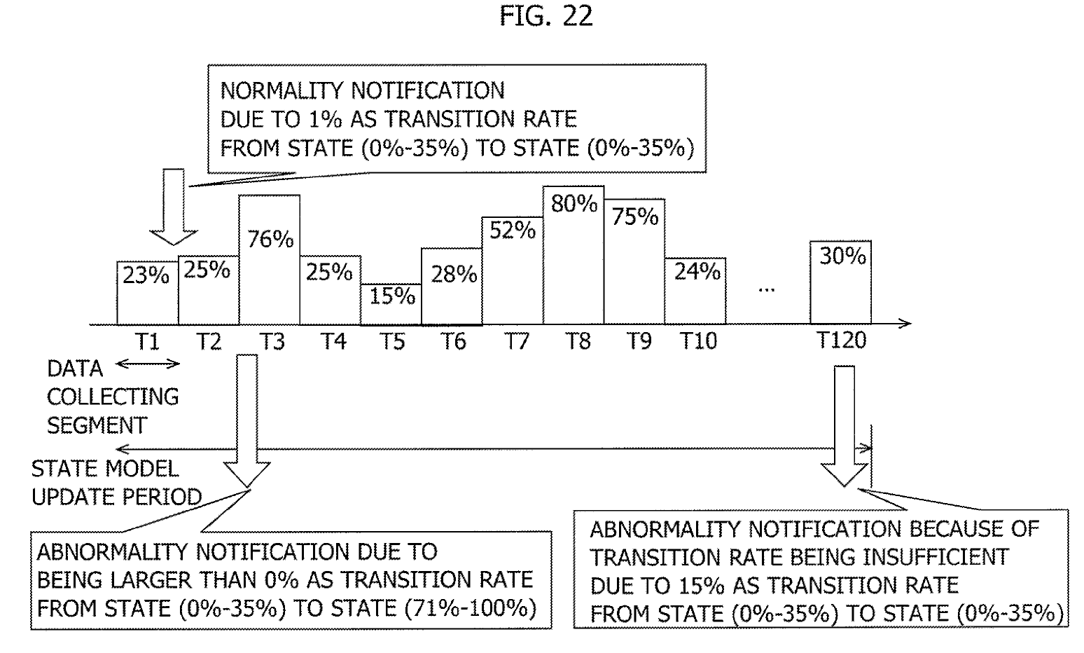

FIG. 22 is a diagram illustrating an example of the abnormality determination in the state model update period in the embodiment 3. In FIG. 22, a determination of whether the abnormality occurs is made based on a comparison with the state model at 11:00 am depicted in FIG. 20B.

In FIG. 22, the state model update period is equally segmented into the 120 data collecting segments T₁ through T₁₂₀. The abnormality detection unit 2 calculates the transition rate between the states before and after the transition in every data collecting segment, and thus determines whether the abnormality occurs. The abnormality detection unit 2 can determine the abnormality when the calculated transition rate exceeds a corresponding transition rate between the states in the state model.

The determination about whether abnormal or not is not limited to the determination about whether or not over the corresponding transition rate between the states in the state model. The abnormality detection unit 2 may determine the abnormality when equal to or larger by, e.g., (state model transition rate+x) % than a predetermined threshold value x. The abnormality detection unit 2 may also determine the abnormality when equal to or larger by {(transition rate between corresponding states in state model)×(1+y/100)}% than a predetermined threshold value y. The threshold values x, y can be set by taking account of the properties instanced by the number of data collecting segments or a degree of variation of the collected data.

The determination of whether the abnormality occurs is made also at the time point of the expiration of the state model update period. This is because the determination of whether the transition rate decreases under the allowable range is made at the time point of the expiration of the state model update period. At the time point of the expiration of the state model update period, the abnormality detection unit 2 compares the transition rate between the respective states with the transition rate between the corresponding states in the state model. The abnormality detection unit 2 can determine the abnormality when there exist one or more states in which the transition rate between the states at the time point of the expiration of the state model update period is lower than the transition rate between the corresponding states in the state model.

The determination about whether the transition rate between the states is lower than the transition rate between the corresponding states in the state model may also be made based on whether equal to or smaller by ((transition rate between corresponding states in state model)−x) % than, e.g., the predetermined threshold value x. The determination about whether the transition rate between the states is lower than the transition rate between the corresponding states in the state model may also be made based on whether equal to or smaller by {(transition rate between corresponding states in state model)×(1−y/100)}% than the predetermined threshold value y. The threshold values x, y can be set by taking account of, e.g., the number of data collecting segments or the properties instanced by the dispersion of the collected data.

A specific example of the abnormality determination in FIG. 22 will hereinafter be described. At such a time point that becoming the data collecting segment T₂ from T₁, it follows that the transition from the state (0%-35%) to the state (0%-35%) occurs at least once. Accordingly, at the time point when becoming the data collecting segment T₂ from T₁, the transition rate is calculated at approximately 0.8% given by (1/120)×100. In the state mode in FIG. 20B, the transition rate from the state (0%-35%) to the state (0%-35%) is 83%, and the transition rate at the time point when becoming the data collecting segment T₂ from T₁ is lower than 83%, thereby determining the normality.

It also follows that the transition from the state (0%-35%) to the state (71%-100%) occurs at least once at the time point when becoming the data collecting segment T₃ from T₂. Therefore, at the time point when becoming the data collecting segment T₃ from T₂, the transition rate is calculated at approximately 0.8% given by (1/120)×100. In the state model in FIG. 20B, the transition rate from the state (0%-35%) to the state (71%-100%) is 0%, and the transition rate at the time point when becoming the data collecting segment T₃ from T₂ is equal to or larger than 0%, thereby determining the abnormality.

After collecting the data of the data collecting segment T₁₂₀, i.e., at the time point of the expiration of the state model update period, the transition rate from the state (0%-35%) to the state (0%-35%) is assumed to be 15%. In the state model in FIG. 20B, the transition rate from the state (0%-35%) to the state (0%-35%) is 25%, and the transition rate after the expiration time of the state model update period is lower than 25%, thereby determining the abnormality.

<Processing Flow>

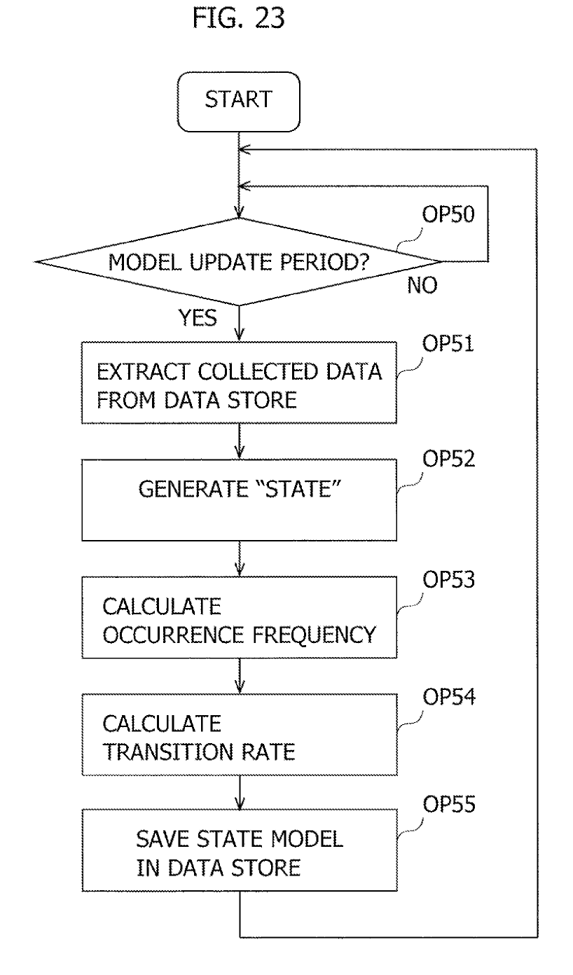

FIG. 23 is a flowchart illustrating an example of the process of generating the state model in the embodiment 3. The process of generating the state model in the embodiment 3 is the same as in the embodiment 1 except the process of calculating the transition rate. To be specific, processes in OP50 through OP53 in FIG. 23 are the same as the processes in OP20 through OP23 in FIG. 16, and hence the explanations of the common portions are omitted.

In OP53, upon calculating the occurrence frequency per state, the processing advances to OP54. In OP54, the abnormality detection unit 2 calculates the transition rate between the states.

In OP55, the abnormality detection unit 2 saves the state models generated in the processes of OP51 through OP54 in the data store 3. The processing loops back to OP50, and the state model generation process is iterated. The generation of the state model is finished by, e.g., the user's instruction.

The process in OP51 is one example of “first acquiring data about a predetermined item of a processing apparatus per segment from the processing apparatus, the segment being obtained by segmenting one period into a plurality of segments, the processing apparatus iteratively executing processes”. The process in OP52 is one example of “first classifying the data acquired by the first acquiring into a plurality of groups by a predetermined classification criterion” The process in OP54 is one example of a process “storing transition rate between the plurality of groups in the data acquired in the one period”.

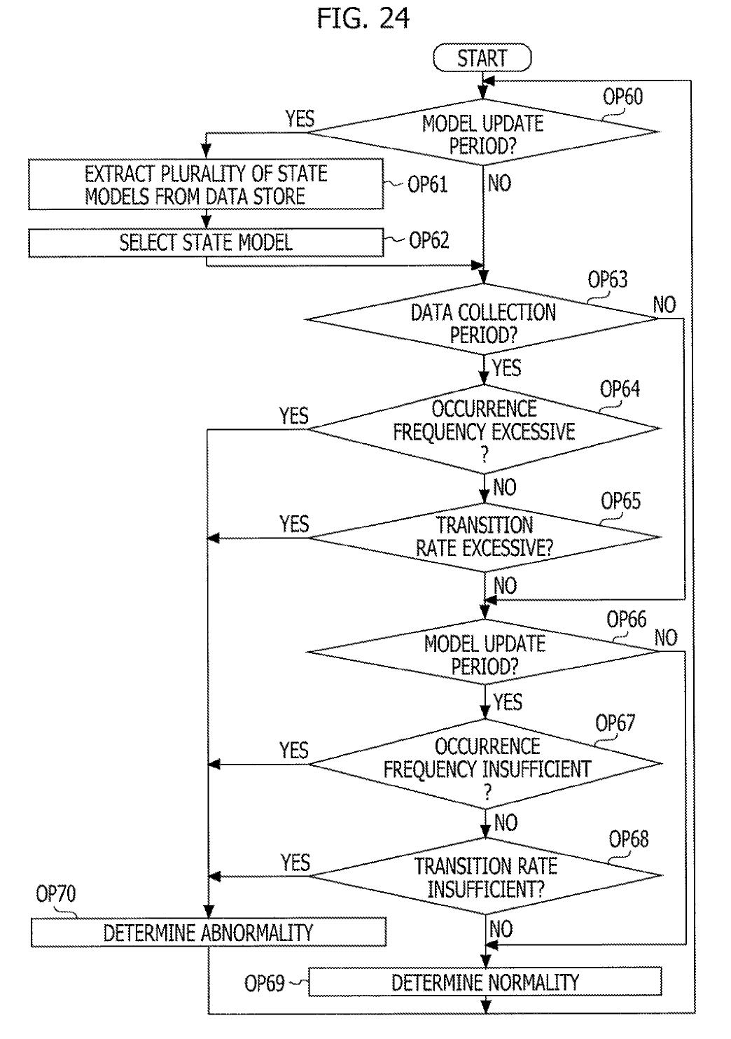

FIG. 24 is a flowchart illustrating an example of the abnormality determination process in the embodiment 3. For example, a start of processes illustrated in FIG. 24 is triggered upon a user's instruction to detect the abnormality in the abnormality detection target processing apparatus 4.

In OP60, the abnormality detection unit 2 determines whether the present time point is the time point of the expiration of the state model update period. When the present time point is the time point of the expiration of the state model update period (OP60: Yes), the processing advances to OP61. Whereas when the present time point is not the time point of the expiration of the state model update period (OP60: No), the processing advances to OP63.

In OP61, the abnormality detection unit 2 extracts the plurality of state models from the data store 3, corresponding to the method of selecting the state model. In OP62, the abnormality detection unit 2 selects the state model becoming the criterion for determining the abnormality.

In OP63, the abnormality detection unit 2 determines whether the present time point is the time point of an expiration of the data collecting segment. When the present time point is the time point of an expiration of the data collecting segment (OP63: Yes), the processing advances to OP64. Whereas when the present time point is not the time point of an expiration of the data collecting segment (OP63: No), the processing advances to OP66.

In OP64, the abnormality detection unit 2 collects the data in the expired data collecting segment, and calculates the occurrence frequency of the state containing the collected data. The abnormality detection unit 2 determines whether the calculated occurrence frequency is excessive by comparing the calculated occurrence frequency with the occurrence frequency of the corresponding state of the state model selected in OP62. When the calculated occurrence frequency is excessive (OP64: Yes), the processing advances to OP70. Whereas when the calculated occurrence frequency is not excessive (OP64: No), the processing advances to OP65.

In OP65, the abnormality detection unit 2 calculates the transition rate about the state-to-state transition that occurs after the data collecting segment in OP63. The calculated transition rate is stored as the state-to-state transition rate at the present time point in the data store 3. The abnormality detection unit 2 is to retain the calculated transition rate in the data store 3 also in the subsequent processes.

The abnormality detection unit 2 determines whether the calculated transition rate is excessive by comparing the calculated transition rate with the transition rate of the transition between the corresponding states in the state model selected in OP62. When the calculated transition rate is excessive (OP65: Yes), the processing advances to OP70. Whereas when the calculated transition rate is not excessive (OP65: No), the processing advances to OP66.

In OP66, the abnormality detection unit 2 determines whether the present time point is the time point of the expiration of the state model update period. When the present time point is the time point of the expiration of the state model update period (OP66: Yes), the processing advances to OP67. Whereas when the present time point is not the time point of the expiration of the state model update period (OP66: No), the processing advances to OP69.

In OP67, the abnormality detection unit 2 calculates the occurrence frequency of the state containing the data collected in the data collecting segment in OP63. The abnormality detection unit 2 determines whether the occurrence frequency of each state is insufficient by comparing the occurrence frequency of each state with the occurrence frequency of the corresponding state in the state model selected in OP62. When there are one or more states with the occurrence frequency being insufficient (OP67: Yes), the processing advances to OP70. Whereas when there is none of the state with the occurrence frequency being insufficient (OP67: No), the processing advances to OP68.

In OP68, the abnormality detection unit 2 calculates the transition rate about the state-to-state transition that occurs after the data collecting segment in OP63. The abnormality detection unit 2 determines whether the transition rate between the states is insufficient by comparing the transition rate between the states with the transition rate between the corresponding states in the state model selected in OP62. When there are one or more state-to-state transitions with the transition rate being insufficient (OP68: Yes), the processing advances to OP70. Whereas when there is none of the state-to-state transition with the transition rate being insufficient (OP68: No), the processing advances to OP69.

In OP69, the abnormality detection unit 2 determines the normality, and the processing loops back to OP60. In OP70, the abnormality detection unit 2 determines the abnormality, and the processing loops back to OP60. Upon looping back to OP60, the abnormality determination process is iterated. The abnormality determination process illustrated in FIG. 24 is finished by, e.g., the user's instruction.

The processes in OP65 and OP68 are one example of a process of “determining the existence of the abnormality in the processing apparatus when the transition rate between the plurality of groups in the determination target period deviates from an allowable range based on a transition rate between corresponding groups in the data acquired in the one period”.

<Operational Effect of Embodiment 3>

The abnormality detection apparatus 10, similarly to the embodiments 1 and 2, determines the abnormality on the basis of the occurrence frequency, and implements the abnormality determination based on the transition rate between the states. The abnormality detection apparatus 10 is thereby enabled to further accurately detect the abnormality related to the state transition in addition to the abnormality related to the occurrence frequency. The abnormality related to the state transition is instanced by a pattern of variation or a degree of variation of the observed value of the collected data.

### Modified Example

In the embodiment 3, the abnormality detection apparatus 10 determines whether abnormal or not on the basis of each of the occurrence frequency and the transition rate, but may also detect the abnormality by determining whether abnormal or not on the basis of the transition rate without implementing the abnormal determination related to the occurrence frequency.

In the case of implementing the abnormal determination based on the transition rate, the abnormality detection apparatus 10, similarly to the embodiment 3, generates the state model containing the transition rate between the states with the collected data being classified. The abnormality detection apparatus 10 can generate the state model containing the transition rate between the states in the processes of, e.g., OP50-OP52, OP54 and OP55 illustrated in FIG. 23.

The abnormality detection apparatus 10 determines the abnormality by collecting the data about the predetermined item from the processing apparatus 4 in every data collecting segment of the determination target period, and making the comparison with the state model containing the transition rate between the states generated by classifying the collected data. The abnormality detection apparatus 10 can implement the abnormality determination in the determination target period in the processes of, e.g., OP60-OP63, OP65, OP66 and OP68-OP70 illustrated in FIG. 24.

The abnormality detection apparatus 10 may also select the state model becoming the criterion for determining the abnormality from the plurality of normal patterns on the basis of the similarity degree of the transition rate between the states in the process of selecting the state model in OP62. The abnormality detection apparatus 10 can further accurately detect the abnormality related to the state transition by focusing on the transition rate between the states.

Note that the processing apparatus 4 becoming the abnormality detection target apparatus in the embodiment is described as the apparatus connected to the abnormality detection apparatus 10 via the network interface 16, and, however, the abnormality detection target apparatus may also be abnormality detection apparatus 10 itself. In this case, it may be sufficient that the abnormality detection apparatus 10 implements the abnormality determination by collecting the self data indicating the settings/states thereof. The configurations of the embodiments discussed above can be adequately combined.

According to one aspect, it is feasible to further accurately detect the abnormality in the processing apparatus and other equivalent apparatuses iteratively executing the processes.

<Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM (Read-Only Memory) and other equivalent recording mediums are given as the non-transitory recording mediums fixed within the computer and other equivalent apparatuses. Further, a solid state drive (SSD) is also available as the non-transitory recording medium removable from the computer and other equivalent apparatuses and also as the non-transitory recording medium fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An abnormality detection method executed by a computer, the abnormality detection method comprising:
first acquiring data about a predetermined item of a processing apparatus per segment from the processing apparatus, the segment being obtained by segmenting one period into a plurality of segments, the processing apparatus iteratively executing processes;
first classifying the data acquired by the first acquiring into a plurality of groups by a predetermined classification criterion;
first storing an occurrence frequency of the data in the one period per group;
second acquiring data about the predetermined item per segment in a determination target period, the determination target period having a same length as a length of the one period; and
first determining existence of abnormality in the processing apparatus when occurrence frequency of data in the determination target period per group deviates from an allowable range based on the occurrence frequency of the data in the one period.

2. The abnormality detection method according to claim 1, wherein the first determining includes determining the existence of the abnormality in the processing apparatus when the occurrence frequency of the data in the determination target period per group exceeds an upper limit value of the allowable range in each segment of the determination target period.

3. The abnormality detection method according to claim 1, wherein the first determining includes determining the existence of the abnormality in the processing apparatus when the occurrence frequency of the data in the determination target period of one or more groups in the plurality of groups decreases under a lower limit value of the allowable range at expiration time of the determination target period.

4. The abnormality detection method according to claim 1, wherein the first classifying includes classifying the data acquired by the first acquiring into a predetermined number of groups and wherein the abnormality detection method further includes:
changing group to which each piece of data belongs on the basis of a difference from an average value of data belonging to each of the groups;
second determining whether to further segment each of the predetermined number of groups on the basis of a value of an indicator for evaluating a segmented state; and
second classifying the data acquired by the first acquiring into a plurality of groups by iterating segmentation till the value of the indicator for evaluating the segmented state fulfills a predetermined condition with respect to the group determined to be segmented.

5. The abnormality detection method according to claim 1, wherein the abnormality detection method further comprises:
generating a plurality of occurrence frequencies of the data in the one period per group;
second storing the plurality of occurrence frequencies generated by the generating as a plurality of normal patterns; and
selecting the normal pattern satisfying a predetermined condition from the plurality of stored normal patterns,
wherein the first determining includes determining the existence of the abnormality in the processing apparatus when the occurrence frequency of the data acquired by the second acquiring per group deviates from an allowable range based on the selected normal pattern.

6. The abnormality detection method according to claim 5, wherein the selecting includes selecting the normal pattern of a period next to the normal pattern having a most similarity to the normal pattern of an immediate period from the normal patterns of the respective periods until a predetermined period of time ago including the plurality of periods in the plurality of normal patterns.

7. The abnormality detection method according to claim 6, wherein the selecting includes selecting a latest normal pattern in the normal patterns stored per predetermined period of time when a similarity degree between two consecutive past normal patterns stored per predetermined period of time is larger than a similarity degree between the normal pattern of the immediate period and the normal pattern exhibiting a highest similarity degree to the normal pattern of the immediate period in the normal patterns of the respective normal patterns until the predetermined period of time ago.

8. The abnormality detection method according to claim 6, wherein the abnormality detection method further comprises:
rearranging the data acquired in the periods of two comparison target normal patterns in an ascending or descending sequence;
calculating a total sum of differences of the data per segment; and
third determining the similarity degree to be higher between the two comparison target normal patterns as the total sum of the differences is smaller.

9. The abnormality detection method according to claim 1,
wherein the first storing includes storing transition rate between the plurality of groups in the data acquired in the one period and
wherein the first determining includes determining the existence of the abnormality in the processing apparatus when the transition rate between the plurality of groups in the determination target period deviates from an allowable range based on a transition rate between corresponding groups in the data acquired in the one period.

10. An abnormality detection method executed by a computer, the abnormality detection method comprising:
first acquiring data about a predetermined item of a processing apparatus per segment from the processing apparatus, the segment being obtained by segmenting one period into a plurality of segments, the processing apparatus iteratively executing processes;
classifying the data acquired by the first acquiring into a plurality of groups by a predetermined classification criterion;
storing a transition rate between the plurality of groups in the data acquired in the one period;
second acquiring the data about the predetermined item per segment in a determination target period, the determination target period having a same length as a length of the one period; and
determining existence of abnormality in the processing apparatus when a transition rate between the plurality of groups in the determination target period deviates from an allowable range based on a transition rate between corresponding groups in the data acquired in the one period.

11. A non-transitory computer-readable recording medium having stored therein a program of an abnormality detection apparatus including a processor, the program to cause the processor to perform:
first acquiring data about a predetermined item of a processing apparatus per segment from the processing apparatus, the segment being obtained by segmenting one period into a plurality of segments, the processing apparatus iteratively executing processes;
classifying the data acquired by the first acquiring into a plurality of groups by a predetermined classification criterion;
storing an occurrence frequency of the data in the one period per group;
second acquiring data about the predetermined item per segment in a determination target period, the determination target period having a same length as a length of the one period; and
determining existence of abnormality in the processing apparatus when occurrence frequency of data in the determination target period per group exceeds an allowable range based on the occurrence frequency of the data in the one period.
